(19) United States
(12) Patent Application Publication
(10) Pub. No.: US 2026/0140633 A1
(43) Pub. Date: May 21, 2026

(54) SEMICONDUCTOR DEVICES, METHODS OF OPERAING SEMICONDUCTOR DEVICE, SYSTEMS, AND DEVICES

(71) Applicant: Yangtze Memory Technologies Holding Co., Ltd., Wuhan (CN)

(72) Inventors: Yu Zhang, Wuhan (CN); Feng Xu, Wuhan (CN); Wendong Wang, Wuhan (CN); Yuanyuan Min, Wuhan (CN); Xinran Li, Wuhan (CN); Da Li, Wuhan (CN); Lei Jin, Wuhan (CN); Zongliang Huo, Wuhan (CN)

(21) Appl. No.: 19/238,068

(22) Filed: Jun. 13, 2025

(30) Foreign Application Priority Data
Nov. 18, 2024 (CN) 202411653308.6

(51) Int. Cl. G06F 3/06

(52) U.S. Cl. CPC G06F 3/0613; G06F 3/064; G06F 3/0679

(57) ABSTRACT

According to one aspect of the present disclosure, a semiconductor device is provided. The semiconductor device may include a peripheral circuit. The semiconductor device may include a memory cell array. The peripheral circuit may be coupled to the memory cell array, the memory cell array may include a plurality of memory regions, and each memory region may include a first number of memory blocks. The peripheral circuit may be configured to receive an operation instruction. The operation instruction may include address information for determining a target memory region in the plurality of memory regions and a second number of working memory blocks in the target memory region. The second number may be less than the first number. The peripheral circuit may be configured to perform a corresponding operation on the working memory blocks in response to the operation instruction.

### CROSS-REFERENCE TO RELATED APPLICATIONS

This application claims the benefit of priority to Chinese Application No. 202411653308.6, filed on Nov. 18, 2024, which is hereby incorporated by reference in its entirety.

### FIELD OF TECHNOLOGY

The present disclosure relates to the field of semiconductor technologies, and in particular, to a semiconductor device, a method of operating the semiconductor device, a system, and a device.

### BACKGROUND

Semiconductor devices, such as NAND, can perform various operations, such as read, program (write) and erase, etc., so as to change a threshold voltage of each memory cell to a desired level. For a NAND semiconductor device, an erase operation may be performed on a memory block level, a program operation may be performed on a page level, and a read operation may be performed on a page level. However, it is difficult to ensure consistency of the state of the memory block due to the influence of the manufacturing process and the number of times of erases and writes, where a generated failure memory block may cause instability of various operations, resulting in poor reliability of the semiconductor device.

### SUMMARY

According to one aspect of the present disclosure, a semiconductor device is provided. The semiconductor device may include a peripheral circuit. The semiconductor device may include a memory cell array. The peripheral circuit may be coupled to the memory cell array, the memory cell array may include a plurality of memory regions, and each memory region may include a first number of memory blocks. The peripheral circuit may be configured to receive an operation instruction. The operation instruction may include address information for determining a target memory region in the plurality of memory regions and a second number of working memory blocks in the target memory region. The second number may be less than the first number. The peripheral circuit may be configured to perform a corresponding operation on the working memory blocks in response to the operation instruction.

In some implementations, a third number of memory blocks in the first number of memory blocks may act as extra memory blocks, and a sum of the second number and the third number may be equal to the first number.

In some implementations, the first number of memory blocks may include a third number of failure memory blocks. In some implementations, a sum of the second number and the third number may be equal to the first number. In some implementations, the peripheral circuit may be configured to receive a first operation instruction and a second operation instruction. In some implementations, address information in the first operation instruction and address information in the second operation instruction may be for determining the same memory region in the plurality of memory regions and the second number of working memory blocks in the same memory region. In some implementations, the peripheral circuit may be configured to perform a corresponding operation on the second number of working memory blocks in response to the first operation instruction and the second operation instruction.

In some implementations, the first number of memory blocks may include a fourth number of failure memory blocks, and a sum of the fourth number and the second number is less than the first number. In some implementations, the second number of memory blocks in a fifth number of normal memory blocks may act as working memory blocks, and a sum of the fifth number and the fourth number may be equal to the first number.

In some implementations, a plurality of operation instructions may include a first operation instruction and a second operation instruction. In some implementations, the address information in the first operation instruction may be for determining a first memory region in the plurality of memory regions and the second number of working memory blocks in the first memory region. In some implementations, the second operation instruction may be for determining a second memory region in the plurality of memory regions and the second number of working memory blocks in the second memory region. In some implementations, when the first memory region and the second memory region are the same memory region, the second number of working memory blocks in the first memory region may be different from the second number of working memory blocks in the second memory region.

In some implementations, the first number of memory blocks may include a sixth number of failure memory blocks. In some implementations, a difference between a physical address of any failure memory block in the sixth number of failure memory blocks and a physical address of any normal memory block in a seventh number of normal memory blocks may be less than a preset threshold. In some implementations, a sum of the sixth number and the seventh number may be equal to the first number.

In some implementations, in each memory region, a physical distance between any two memory blocks in the first number of memory blocks may be less than a threshold.

In some implementations, the address information may include an address of the target memory region and addresses of the third number of extra memory blocks.

In some implementations, the peripheral circuit may include a memory region decoding circuit, a memory block decoding circuit, an XOR logic circuit, and a memory block enable circuit coupled in sequence.

In some implementations, the first number of memory blocks may include a third number of extra memory blocks, a sum of the second number and the third number may be equal to the first number, and the address information may include an address of the target memory region and addresses of the third number of extra memory blocks. In some implementations, the memory region decoding circuit may be configured to output a first enable signal according to the address of the target memory region. In some implementations, the memory block decoding circuit may be configured to output a second enable signal according to the addresses of the third number of extra memory blocks and the first enable signal. In some implementations, the XOR logic circuit may be configured to receive a third enable signal, and output a fourth enable signal according to the second enable signal and the third enable signal. In some implementations, the fourth enable signal may be an XOR result of the second enable signal and the third enable signal. In some implementations, the memory block enable circuit may be configured to output a fifth enable signal to the second number of working memory blocks according to the fourth enable signal. In some implementations, the fifth enable signal may be for strobing the second number of working memory blocks.

In some implementations, at least two of the plurality of memory regions may share the third number of extra memory blocks.

In some implementations, the operation instruction may further include a sixth enable signal. In some implementations, the sixth enable signal may be for indicating that the target memory region is configured to perform a data storage operation. In some implementations, the peripheral circuit may be further configured to write stored data to the target memory region in response to the operation instruction. In some implementations, the peripheral circuit may be further configured to read stored data from the target memory region in response to the operation instruction. In some implementations, the peripheral circuit may be further configured to erase stored data in the target memory region in response to the operation instruction.

In some implementations, the operation instruction may further include a seventh enable signal. In some implementations, the seventh enable signal may be for indicating that the target memory region is configured to perform a computing-in-memory operation. In some implementations, the peripheral circuit may be configured to input operation data to the second number of working memory blocks to obtain an operation result in response to the operation instruction. In some implementations, the operation result may be an operation result of the operation data and data stored in the working memory blocks.

In some implementations, the working memory blocks may each include a plurality of select lines and memory strings. In some implementations, the memory strings may each include a plurality of transistors. In some implementations, drain lines and source lines of the plurality of transistors may be alternately coupled to each other, and a select line may be coupled to a gate line of a transistor at one end of the memory string. In some implementations, the peripheral circuit may be configured to, in response to the operation instruction, input operation data to the plurality of select lines in the working memory block to obtain an operation result.

According to another aspect of the present disclosure, a semiconductor device is provided. The semiconductor device may include a peripheral circuit. The semiconductor device may include a memory cell array. The memory cell array may be coupled to the peripheral circuit, and the memory cell array may include a plurality of first-level memory elements each including a plurality of memory blocks. The plurality of memory blocks may be configured in a plurality of second-level memory elements each including a first number of memory blocks. A second number of memory blocks in the first number of memory blocks may act as working memory blocks. The second number may be less than the first number.

In some implementations, a third number of memory blocks in the first number of memory blocks may act as extra memory blocks, and a sum of the second number and the third number may be equal to the first number.

In some implementations, at least two of the plurality of second-level memory elements may share the third number of extra memory blocks.

In some implementations, the first number of memory blocks may include a fourth number of failure memory blocks, and a sum of the fourth number and the second number may be less than the first number. In some implementations, the second number of memory blocks in a fifth number of normal memory blocks may act as working memory blocks, and a sum of the fifth number and the fourth number may be equal to the first number.

In some implementations, the first number of memory blocks may include a sixth number of failure memory blocks. In some implementations, a difference between a physical address of any failure memory block in the sixth number of failure memory blocks and a physical address of any normal memory block in a seventh number of normal memory blocks may be less than a preset threshold. In some implementations, a sum of the sixth number and the seventh number may be equal to the first number.

In some implementations, in each second-level memory element, a physical distance between any two memory blocks in the first number of memory blocks may be less than a threshold.

In some implementations, the peripheral circuit may include a memory region decoding circuit, a memory block decoding circuit, an XOR logic circuit, and a memory block enable circuit coupled in sequence.

In some implementations, the peripheral circuit may be configured to receive an operation instruction. In some implementations, the operation instruction may include address information for determining a target second-level memory element and the second number of working memory blocks in the target second-level memory element. In some implementations, the peripheral circuit may be configured to perform a data operation on the working memory blocks in response to the operation instruction.

In some implementations, a third number of memory blocks in the first number of memory blocks may act as extra memory blocks, and a sum of the second number and the third number is equal to the first number. In some implementations, the address information may include an address of the target second-level memory element and addresses of the third number of extra memory blocks.

In some implementations, the peripheral circuit may include a memory region decoding circuit, a memory block decoding circuit, an XOR logic circuit, and a memory block enable circuit coupled in sequence. In some implementations, the first number of memory blocks may include a third number of extra memory blocks, and a sum of the second number and the third number is equal to the first number. In some implementations, the address information may include an address of the target second-level memory element and addresses of the third number of extra memory blocks. In some implementations, the memory region decoding circuit may be configured to output a first enable signal according to the address of the target second-level memory element. In some implementations, the memory block decoding circuit may be configured to output a second enable signal according to the addresses of the third number of extra memory blocks and the first enable signal. In some implementations, the XOR logic circuit may be configured to receive a third enable signal, and output a fourth enable signal according to the second enable signal and the third enable signal. In some implementations, the fourth enable signal may be an XOR result of the second enable signal and the third enable signal. In some implementations, the memory block enable circuit may be configured to output a fifth enable signal to the second number of working memory blocks according to the fourth enable signal. In some implementations, the fifth enable signal may be for strobing the second number of working memory blocks.

In some implementations, the operation instruction may further include a sixth enable signal, and the sixth enable signal may be for indicating that the target second-level memory element is configured to perform a data storage operation. In some implementations, the peripheral circuit may be further configured to write stored data to the second-level memory element in response to the operation instruction. In some implementations, the peripheral circuit may be further configured to read stored data from the second-level memory element in response to the operation instruction. In some implementations, the peripheral circuit may be further configured to erase stored data in the second-level memory element in response to the operation instruction.

In some implementations, the operation instruction may further include a seventh enable signal, and the seventh enable signal may be for indicating that the target second-level memory element is configured to perform a computing-in-memory operation. In some implementations, the peripheral circuit may be further configured to input operation data to the working memory blocks to obtain an operation result in response to the operation instruction. In some implementations, the operation result may be an operation result of the operation data and data stored in the working memory blocks.

In some implementations, the working memory blocks may each include a plurality of select lines and memory strings. In some implementations, the memory strings may each include a plurality of transistors. In some implementations, drain lines and source lines of the plurality of transistors may be alternately coupled to each other. In some implementations, a select line may be coupled to a gate line of a transistor at one end of the memory string. In some implementations, the peripheral circuit may be configured to, in response to the operation instruction, input operation data to the plurality of select lines in the working memory block to obtain an operation result.

In some implementations, the semiconductor device may be a die including a plurality of memory planes, the first-level memory element may be a memory plane including a plurality of memory banks, and the second-level memory element may be a memory bank including a plurality of memory blocks.

According to a further aspect of the present disclosure, a method of operating a semiconductor device is provided. The method may include receiving an operation instruction. The operation instruction may include address information for determining a target memory region in a plurality of memory regions and a second number of working memory blocks in the target memory region. Each memory region may include a first number of memory blocks, and the second number may be less than the first number. The method may include performing a corresponding operation on the working memory blocks in response to the operation instruction.

In some implementations, the first number of memory blocks may include a third number of failure memory blocks, and a sum of the second number and the third number may be equal to the first number. In some implementations, the receiving the operation instruction may include receiving a first operation instruction and a second operation instruction. In some implementations, address information in the first operation instruction and address information in the second operation instruction may be for determining the same memory region in the plurality of memory regions and the second number of working memory blocks in the same memory region. In some implementations, the performing the corresponding operation on the working memory blocks in response to the operation instruction may include performing a corresponding operation on the second number of working memory blocks in response to the first operation instruction and the second operation instruction.

In some implementations, the first number of memory blocks may include a third number of extra memory blocks, a sum of the second number and the third number may be equal to the first number, and the address information may include an address of the target memory region and addresses of the third number of extra memory blocks. In some implementations, the method may further include outputting a first enable signal according to the address of the target memory region. In some implementations, the method may further include outputting a second enable signal according to the addresses of the third number of extra memory blocks and the first enable signal. In some implementations, the method may further include receiving a third enable signal, and outputting a fourth enable signal according to the second enable signal and the third enable signa. In some implementations, the fourth enable signal may be an XOR result of the second enable signal and the third enable signal. In some implementations, the method may further include outputting a fifth enable signal to the second number of working memory blocks according to the fourth enable signal. In some implementations, the fifth enable signal may be for strobing the second number of working memory blocks.

In some implementations, the operation instruction may further include a sixth enable signal, and the sixth enable signal may be for indicating that the target memory region is configured to perform a data storage operation. In some implementations, the method may further include writing stored data to the target memory region in response to the operation instruction. In some implementations, the method may further include reading stored data from the target memory region in response to the operation instruction. In some implementations, the method may further include erasing stored data in the target memory region in response to the operation instruction.

In some implementations, the operation instruction may further include a seventh enable signal, and the seventh enable signal may be for indicating that the target memory region is configured to perform a computing-in-memory operation. In some implementations, in response to the operation instruction, the performing the corresponding operation on the working memory blocks may include inputting operation data to the second number of working memory blocks to obtain an operation result in response to the operation instruction. In some implementations, the operation result may be an operation result of the operation data and data stored in the working memory blocks.

In some implementations, the working memory blocks may each include a plurality of select lines and memory strings. In some implementations, the memory strings may each include a plurality of transistors. In some implementations, drain lines and source lines of the plurality of transistors may be alternately coupled to each other. In some implementations, a select line may be coupled to a gate line of a transistor at one end of the memory string. In some implementations, the inputting the operation data to the working memory blocks to obtain the operation result in response to the operation instruction may include inputting operation data to the select lines in the working memory block to obtain an operation result, in response to the operation instruction.

According to yet another aspect of the present disclosure, a system is provided. The system may include a controller and a semiconductor device coupled to the controller. The semiconductor device may include a peripheral circuit and a memory cell array. The peripheral circuit may be coupled to the memory cell array, and the memory cell array may include a plurality of memory regions. Each memory region may include a first number of memory blocks. The peripheral circuit may be configured to receive an operation instruction. The operation instruction may include address information for determining a target memory region in the plurality of memory regions and a second number of working memory blocks in the target memory region, and the second number may be less than the first number. The peripheral circuit may be configured to perform a corresponding operation on the working memory blocks in response to the operation instruction. The system may include a controller and a semiconductor device coupled to the controller. The semiconductor device may include a peripheral circuit and a memory cell array. The semiconductor device may include a peripheral circuit and a memory cell array coupled to the peripheral circuit. The memory cell array may include a plurality of first-level memory elements each including a plurality of memory blocks, the plurality of memory blocks may be configured in a plurality of second-level memory elements each including a first number of memory blocks, a second number of memory blocks in the first number of memory blocks may act as working memory blocks, and the second number may be less than the first number.

According to still a further aspect of the present disclosure, an electronic device is provided. The electronic device may include a host and system coupled to the host. The system may include a controller and a semiconductor device coupled to the controller. The semiconductor device may include a peripheral circuit and a memory cell array. The peripheral circuit may be coupled to the memory cell array, and the memory cell array may include a plurality of memory regions. Each memory region may include a first number of memory blocks. The peripheral circuit may be configured to receive an operation instruction. The operation instruction may include address information for determining a target memory region in the plurality of memory regions and a second number of working memory blocks in the target memory region, and the second number may be less than the first number. The peripheral circuit may be configured to perform a corresponding operation on the working memory blocks in response to the operation instruction. The system may include a controller and a semiconductor device coupled to the controller. The semiconductor device may include a peripheral circuit and a memory cell array. The semiconductor device may include a peripheral circuit and a memory cell array coupled to the peripheral circuit. The memory cell array may include a plurality of first-level memory elements each including a plurality of memory blocks, the plurality of memory blocks may be configured in a plurality of second-level memory elements each including a first number of memory blocks, a second number of memory blocks in the first number of memory blocks may act as working memory blocks, and the second number may be less than the first number.

According to yet a further aspect of the present disclosure, an electronic device is provided. The electronic device may include a host and a semiconductor device coupled to the host. The semiconductor device may include a peripheral circuit and a memory cell array. The peripheral circuit may be coupled to the memory cell array. The memory cell array may include a plurality of memory regions, and each memory region may include a first number of memory blocks. The peripheral circuit may be configured to receive an operation instruction. The operation instruction may include address information for determining a target memory region in the plurality of memory regions and a second number of working memory blocks in the target memory region, and the second number may be less than the first number. The peripheral circuit may be configured to perform a corresponding operation on the working memory blocks in response to the operation instruction. The memory cell array may include a plurality of first-level memory elements each including a plurality of memory blocks, the plurality of memory blocks may be configured in a plurality of second-level memory elements each including a first number of memory blocks, a second number of memory blocks in the first number of memory blocks may act as working memory blocks, and the second number may be less than the first number.

According to yet another aspect of the present disclosure, a computer memory medium including instructions is provided. The instructions, which, when executed on a processor, causes the processor to perform a method of operating a semiconductor device. The method may include receiving an operation instruction. The operation instruction may include address information for determining a target memory region in a plurality of memory regions and a second number of working memory blocks in the target memory region, each memory region may include a first number of memory blocks, and the second number may be less than the first number. The method may include performing a corresponding operation on the working memory blocks in response to the operation instruction.

### BRIEF DESCRIPTION OF THE DRAWINGS

In order to more clearly illustrate the technical solutions in the present disclosure, the drawings, which need to be used in some examples of the present disclosure, are briefly introduced below, and it is apparent that the drawings in the following description are merely drawings of some examples of the present disclosure, and other drawings may be obtained by those skilled in the art based on these drawings. In addition, the drawings in the following description may be regarded as schematic diagrams, and do not limit the actual size of the product, the actual flow of the method, the actual timing of the signal, and the like in the examples of the present disclosure.

FIG. 1 is a first schematic structural diagram of an electronic device according to some examples;

FIG. 2 is second schematic structural diagram of an electronic device according to some examples;

FIG. 3 is a schematic structural diagram of a memory card according to some examples;

FIG. 4 is a schematic structural diagram of a solid state disk according to some examples;

FIG. 5 is a first schematic structural diagram of a semiconductor device according to some examples;

FIG. 6 is a first schematic structural diagram of a memory cell array according to some examples;

FIG. 7 is a second schematic structural diagram of a semiconductor device according to some examples;

FIG. 8 is a third schematic structural diagram of a semiconductor device according to some examples;

FIG. 9 is a third schematic structural diagram of an electronic device according to some examples;

FIG. 10 is a first schematic diagram of a bad block management method according to some examples;

FIG. 11 is a second schematic diagram of a bad block management method according to some examples;

FIG. 12 is a third schematic diagram of a bad block management method according to some examples;

FIG. 13 is a fourth schematic diagram of a bad block management method according to some examples;

FIG. 14 is a second schematic structural diagram of a memory cell array according to some examples;

FIG. 15 is a fifth schematic diagram of a bad block management method according to some examples;

FIG. 16 is a sixth schematic diagram of a bad block management method according to some examples;

FIG. 17 is a fourth schematic structural diagram of a semiconductor device according to some examples;

FIG. 18 is a third schematic structural diagram of a memory cell array according to some examples;

FIG. 19 is a first schematic flowchart of a method of operating a semiconductor device according to some examples;

FIG. 20 is a first schematic structural diagram of a compute-in-memory device according to some examples;

FIG. 21 is a second schematic structural diagram of a compute-in-memory device according to some examples;

FIG. 22 is a third schematic structural diagram of a compute-in-memory device according to some examples;

FIG. 23 is a fifth schematic structural diagram of a semiconductor device according to some examples;

FIG. 24 is a second schematic flowchart of a method of operating a semiconductor device according to some examples; and

FIG. 25 is a third schematic flowchart of a method of operating a semiconductor device according to some examples.

### DETAILED DESCRIPTION

The technical solutions in some examples of the present disclosure will be clearly and fully described below with reference to the drawings, and it is apparent that the described examples are only a part of examples of the present disclosure, and are not all examples. All other examples obtained by those skilled in the art based on the examples provided by the present disclosure fall within the scope of the present disclosure.

In the description of the present disclosure, it should be understood that the orientation or positional relationship indicated by the terms “center”, “upper”, “lower”, “front”, “back”, “left”, “right”, “vertical”, “horizontal”, “top”, “bottom”, “inside”, “outside” and the like is based on the orientation or positional relationship shown in the drawings, and is merely for the purpose of describing the present disclosure and simplifying the description, and is not intended to indicate or imply that the referred device or element must have a specific orientation, be constructed and operated in a specific orientation, and therefore should not be understood as a limitation on the present disclosure.

Unless otherwise required by the context, throughout the specification and claims, the term “comprises” is interpreted as open and inclusive, meaning “comprising, but not limited to”. In the description of the specification, the terms “one example,” “some examples,” “exemplary example,” “for example,” and the like are intended to indicate that a particular feature, structure, material, or characteristic associated with the example is comprised in at least one example of the present disclosure. The schematic representation of the above terms does not necessarily refer to the same example. Further, the particular feature, structure, material, or characteristic described may be comprised in any suitable manner in any one or more examples.

The terms “first” and “second” are used for descriptive purposes only and are not to be construed as indicating or implying relative importance or implicitly indicating the number of indicated technical features. Thus, features defined by “first”, “second” may explicitly or implicitly comprise one or more of the features. In the description of the examples of the present disclosure, unless otherwise indicated, the meaning of “a plurality of” is two or more.

In describing some examples, expressions “coupled to” and “connected to”, and their derivatives may be used. For example, the term “connected to” may be used in describing some examples to indicate that two or more components are in direct physical contact or electrical contact with each other. As another example, the term “coupled to” may be used in describing some examples to indicate that two or more components in direct physical contact or electrical contact with each other. However, the term “coupled to” may also mean that two or more components are not in direct contact with each other but still cooperate or interact with each other. The examples disclosed herein are not necessarily limited to the disclosure herein.

“At least one of A, B, and C” has the same meaning as “at least one of A, B, or C”, both comprising the following combinations of A, B, and C: A only, B only, C only, a combination of A and B, a combination of A and C, a combination of B and C, and a combination of A, B, and C.

“A and/or B” comprises the following three combinations: A only, B only, and a combination of A and B.

The use of “adapted to” or “configured to” herein means an open and inclusive language that does not exclude devices adapted to or configured to perform additional tasks or steps.

In addition, the use of “based on” means open and inclusive, since in practice, the process, step, calculation, or other action “based on” one or more of the conditions or values may be based on additional conditions or beyond the values.

The present disclosure is not limited to three-dimensional (3D) NAND semiconductor devices, although 3D NAND semiconductor devices may be used in some examples to illustrate. For example, the techniques disclosed herein may be applied to planar NAND semiconductor devices and NOR semiconductor devices, and the like.

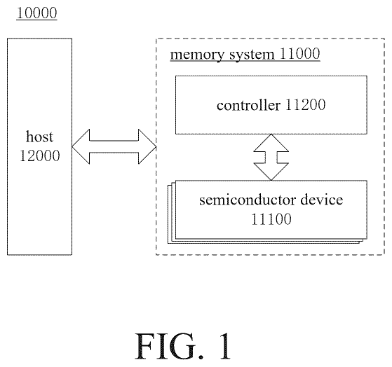

FIG. 1 illustrates a structural diagram of an electronic device 10000 having a semiconductor device according to some aspects. The electronic device 10000 may be a mobile phone (for example, a cellphone), a desktop computer, a tablet computer, a notebook computer, a server, a vehicle-mounted device, a game console, a printer, a positioning device, a wearable device (for example, a smart watch, a smart bracelet, smart glasses, etc.), a smart sensor, a mobile power source, a virtual reality (VR) device, an augmented reality (AR) device, or any other suitable electronic device having a memory therein. As shown in FIG. 1, the electronic device 10000 includes a memory system 11000 and a host 12000. The memory system 11000 includes one or more semiconductor devices 11100 and a controller 11200 coupled to the semiconductor devices 11100. The host 12000 may be a processor of the electronic device 10000, for example, the processor may be a chip, in an example, may be a field programmable gate array (FPGA), may be an application specific integrated circuit (ASIC), or may be a system on chip (SoC), or may be a central processor unit (CPU), or may be a network processor (NP), or may be a digital signal processor (DSP), or may be a microcontroller unit (MCU), or may be a programmable logic device (PLD), or may be an application processor (AP) or another integrated chip.

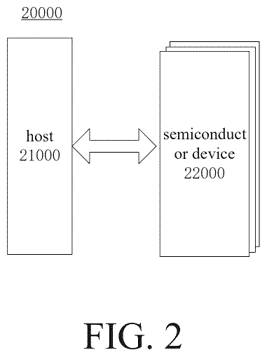

In some possible implementations, FIG. 2 shows a structural diagram of an electronic device 20000 having a semiconductor device, and as shown in FIG. 2, the electronic device 20000 includes a host 21000 and semiconductor devices 22000 (which may also be the semiconductor devices 11100 shown in FIG. 1), and the host 21000 is coupled to the semiconductor devices 22000. A function of the controller 11200 in the memory system 11000 shown in FIG. 1 is integrated in the host 21000 shown in FIG. 2.

This example takes the electronic device 10000 shown in FIG. 1 as an example to illustrate. According to some implementations, the controller 11200 is coupled to the semiconductor devices 11100 and the host 12000 and is configured to control the semiconductor devices 11100. The controller 11200 may manage data stored in the semiconductor devices 11100 and communicate with the host 12000. In some implementations, the controller 11200 is designed to operate in a low duty-cycle environment, such as a secure digital (SD) card, a compact flash card (CF) card, a universal serial bus (USB) flash drive, or other medium used in electronic devices such as personal computers, digital cameras, mobile phones, and the like. In some implementations, the controller 11200 is designed to operate in a high duty-cycle environment, such as a solid state drive (SSD) or embedded multimedia card (eMMC), which is used as a data storage for mobile electronic devices (such as smart phones, tablets, personal computers, and the like) and an enterprise memory array.

The controller 11200 may be configured to manage data stored in the semiconductor devices 11100 and communicate with an external device, such as the host 12000, and control operations of the semiconductor devices 11100, such as read, erase, and program operations.

In some implementations, the controller 11200 is further configured to process error correction code (ECC) related to data read from or written to the semiconductor devices 11100.

The controller 11200 may also perform any other suitable functions, such as formatting the semiconductor devices 11100. The controller 11200 may communicate with an external device (e.g., host 12000) according to a particular communication protocol. For example, the controller 11200 may communicate with an external device through at least one of various interface protocols, such as a USB protocol, a multimedia card (MMC) protocol, a peripheral component interconnect (PCI) protocol, a PCI-express (PCI-E) protocol, an advanced technology attachment (ATA) protocol, a serial ATA protocol, a parallel ATA protocol, a small computer system interface (SCSI) protocol, an enhanced small device interface (ESDI) protocol, an integrated drive electronics (IDE) protocol, a Firewire protocol, or the like.

It should be noted that the interface protocols include at least one of a USB protocol, an MMC protocol, a peripheral component interconnect (PCI) protocol, a PCI-express (PCI-E) protocol, an advanced technology attachment (ATA) protocol, a serial ATA protocol, a parallel ATA protocol, a small computer system interface (SCSI) protocol, an enhanced small device interface (ESDI) protocol, an integrated drive electronics (IDE) protocol, and a Firewire protocol.

The controller 11200 and the one or more semiconductor devices 11100 may be integrated into various types of memory systems 11000, for example, included in the same package, such as an embedded multimedia card (cMMC), a universal flash memory (UFS) package, an embedded multi-chip package (eMCP) package, or a UFS based multichip package (uMCP) package. The eMMC adopts a unified MMC standard interface to package a high-density NAND and a MMC controller in a ball grid array (BGA) packaging chip. The UFS is an advanced version of the eMMC, and is also an array memory module composed of a plurality of flash memory chips and a controller. The UFS makes up the defect that the eMMC supports only half duplex operation (read and write performed separately), and can implement full duplex operation, so performance is doubled. The eMCP is formed by carrying a volatile memory, such as a static random-access memory (SRAM) or a dynamic random-access memory (DRAM), on the eMMC.

In an implementation, the DRAM may be a low-power double data rate SDRAM (LPDDR). The uMCP is packaged by carrying a volatile memory (such as a SRAM or a DRAM) on the UFS, and has high performance and high capacity. In an implementation, the DRAM may be an LPDDR. That is, the memory system 11000 may be implemented and packaged into different types of end electronic devices.

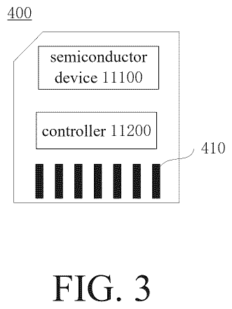

In one example as shown in FIG. 3, the controller 11200 and the single semiconductor devices 11100 may be integrated into a memory card 400. The memory card 400 may include a PC Card (e.g., Personal Computer Memory Card International Association (PCMCIA)), a CF card, a smart media (SM) card, a memory stick, a multimedia card (MMC, reduced size (RS)-MMC, MMCmicro), an SD card (SD, miniSD, microSD, SD high capacity (HC)), UFS, and the like. The memory card 400 may also include a memory card connector 410 that couples the memory card 400 with a host, such as the host 12000 in FIG. 1.

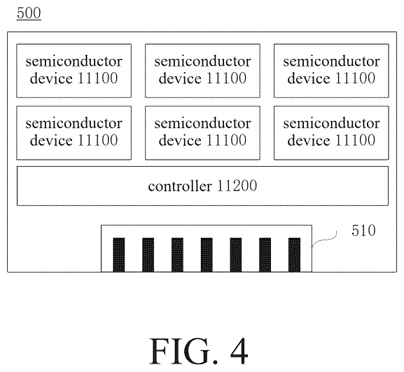

In another example as shown in FIG. 4, the controller 11200 and the plurality of semiconductor devices 11100 may be integrated into a SSD 500. The SSD 500 may also include an SSD connector 510 that couples the SSD 500 with a host, such as host 12000 in FIG. 1. In some implementations, the storage capacity and/or operating speed of the SSD 500 is higher than the storage capacity and/or operating speed of the memory card 400.

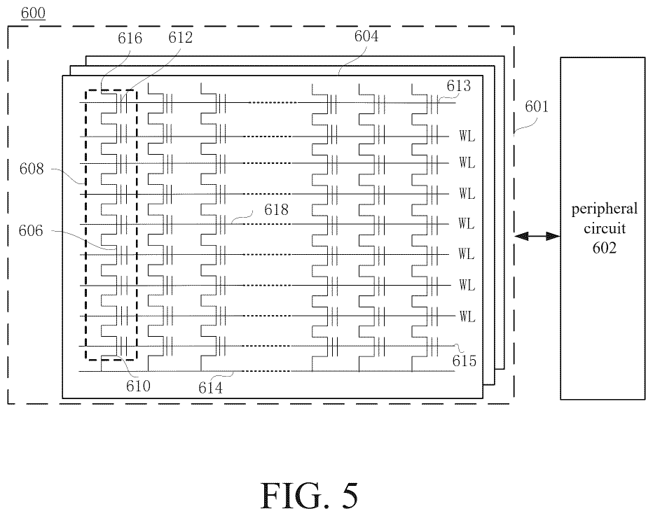

FIG. 5 illustrates a schematic circuit diagram of an exemplary semiconductor device 600 including a peripheral circuit 602 according to some aspects of the present disclosure. The semiconductor device 600 may be an example of a semiconductor device 11100 in FIG. 1. The semiconductor device 600 may include a memory cell array 601 and a peripheral circuit 602 coupled to the memory cell array 601. The memory cell array 601 may be an array of NAND flash memory cells, where the memory cells 606 are provided in the form of an array of NAND memory strings 608 each extending vertically above a substrate (not shown). In some implementations, each NAND memory string 608 includes a plurality of memory cells 606 coupled in series and vertically stacked. Each memory cell 606 can maintain a continuous analog value, e.g., voltage or charge, depending on the number of electrons captured within the area of the memory cell 606. Each memory cell 606 may be a floating-gate type of memory cell including a floating gate transistor or may be a charge-trapping type of memory cell including a charge-trapping transistor.

In some implementations, each memory cell 606 is a single-level cell (SLC) having two possible memory states (levels), and thus capable of storing one bit of data. In an example, each memory cell 606 may be configured to store N bits of data in one of 2^{N} memory states (levels), where N is a natural number greater than 0. The 2^{N} memory states include an erase state and 2^{N}−1 non-erase states. In some implementations, each memory cell 606 is an SLC having two possible memory states (levels) and thus may store one bit of data. For example, the first memory state “0” may correspond to a first range of threshold voltages and the second memory state “1” may correspond to a second range of threshold voltages. In some implementations, each memory cell 606 is an xLC capable of storing more than one bit of data in more than four memory states (levels). For example, the xLC can store two bits per cell (multi-level cell, MLC), three bits per cell (triple-level cell, TLC), or four bits per cell (quad-level cell, QLC). Each xLC may be programmed to assume a range of possible nominal stored values. In one example, the MLC may be programmed from an erase state to assume one of three possible program levels (e.g., 01, 10, and 11) by writing one of three possible nominal stored values to the memory cell 606. The fourth nominal stored value may be used for an erase state (e.g., 00).

As shown in FIG. 5, each NAND memory string 608 may also include a source select gate (SSG) transistor 610 at its source terminal and a drain select gate (DSG) transistor 612 at its drain terminal. The SSG transistor 610 and the DSG transistor 612 may be configured to activate a selected NAND memory string 608 (column of the array) during read and program operations. In some implementations, sources of NAND memory strings 608 in the same block 604 are coupled through the same source line (SL) 614 (e.g., a common SL). In other words, according to some implementations, all of the NAND memory strings 608 in the same memory block 604 have an array common source (ACS). According to some implementations, a drain of each NAND memory string 608 is coupled to a respective bit line 616 from or to which data can be read or written via an output bus (not shown). In some implementations, each NAND memory string 608 is configured to be selected or deselected by applying a select voltage or a deselect voltage to a gate of a respective DSG transistor 612 via one or more DSG lines 613 and/or by applying a select voltage or a deselect voltage to a gate of a respective SSG transistor 610 via one or more SSG lines 615.

As shown in FIG. 5, NAND memory strings 608 may be organized into a plurality of memory blocks 604, each of which may have, for example, a common source line 614 coupled to an ACS. In some implementations, each memory block 604 is a basic data unit for an erase operation, e.g., all memory cells 606 on the same memory block 604 are erased simultaneously. To erase the memory cells 606 in a selected memory block 604, the source lines 614 coupled to the selected memory block 604 and unselected memory blocks 604 in the same plane as the selected memory block 604 may be biased with an erase voltage (Vers), such as a high positive bias voltage (e.g., 20V or higher). The memory cells 606 of adjacent NAND memory strings 608 may be coupled by a word line (WL) 618, which selects which row of memory cells 606 are affected by read and program operations.

As shown in FIG. 5, the memory cell array 601 may include an array of memory cells 606 in a plurality of rows and columns in each memory block 604. According to some implementation, a column of memory cells corresponds to one NAND memory string 608. A plurality of rows of memory cells 606 may be each coupled to a word line 618, and a plurality of columns of memory cells 606 may be each coupled to a bit line 616.

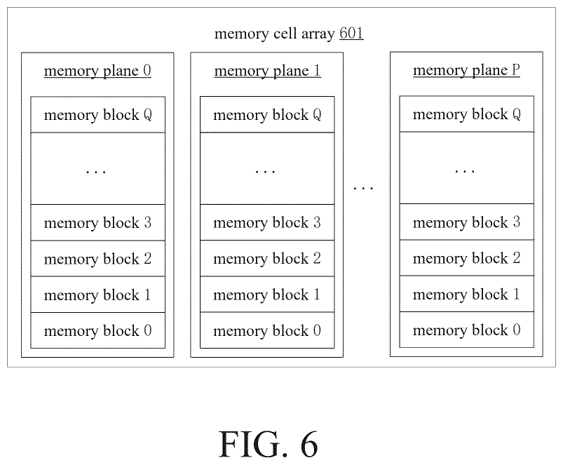

As shown in FIG. 6, the memory cell array 601 may include a plurality of memory planes (a memory plane 0, a memory plane 1, . . . , a memory plane P), where a memory plane is a minimum unit for implementing integration of the memory cell array 601 on process manufacturing. Each memory plane includes a plurality of memory blocks 604 (memory block 0, memory block 1, memory block 2, memory block 3, . . . , memory block Q).

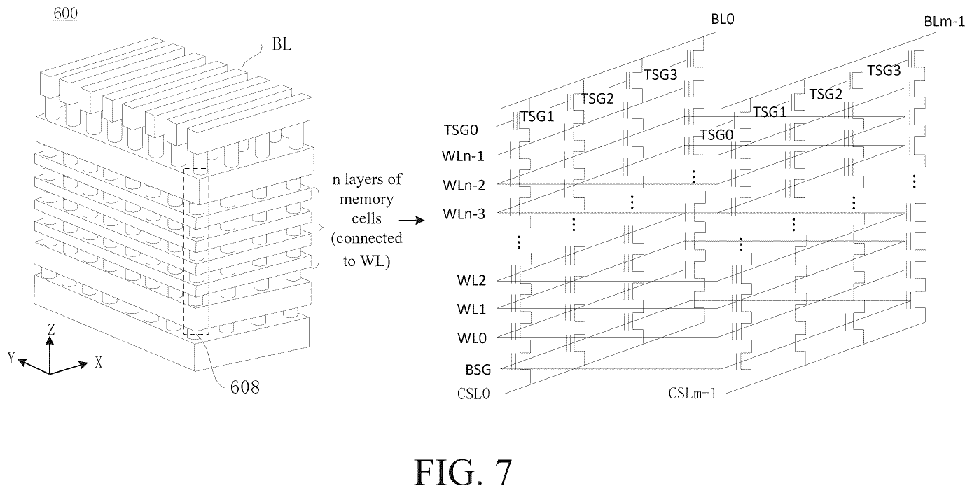

FIG. 7 illustrates a three-dimensional (3D) semiconductor device 600 including a multi-layer stack according to some aspects of the present disclosure. As shown in FIG. 7, the semiconductor device 600 includes a plurality of memory strings 608 and n layers of memory cells (including WL0, WL1, WL2, . . . , WLn−1, WLn−2, WLn−1). The plurality of memory strings 608 included in the semiconductor device 600 are arranged along a direction parallel to a bearing surface of a substrate, and a plurality of memory cells in each memory string 608 are arranged along a direction perpendicular to the bearing surface of the substrate. That is, the plurality of memory cells included in the semiconductor device 600 are arranged in a three-dimensional array on the substrate, and form a memory cell array.

One end of a memory string 608 is connected to a bit line 616 (including BL0, BL2, . . . , BLm−1), and the other end is connected to a common source line (CSL) or an array common source (ACS). The BSG of the memory string 608 may be coupled to the same CSL, or may be coupled to different CSLs (as shown in FIG. 7, CSL0, . . . , CSLm−1), which is not limited herein.

The memory cells 606 in each memory string 608 are also connected to memory cells 606 in other memory strings through word lines 618. For example, if each memory string 608 may include 64 memory cells 606, the 3D semiconductor device may include 64 word lines 618 WL [63:0], with each word line 618 connected to a portion of memory cells 606 located in the same layer (e.g., having the same height relative to the substrate). It should be noted that the 64 memory cells 606 are only an example, and the present disclosure is not limited thereto. In some examples, each memory string 608 may include more than 64 memory cells 606, e.g., 128, 196, etc. In the 3D semiconductor device 600, the memory cells 606 connected to the same word line 618 is referred to as a memory page, and all memory strings 608 sharing a group of word lines 618 are referred to as a memory block.

A memory string 608 further includes an upper select transistor connected to the drain of the first memory cell 606, and a lower select transistor connected to the source of the last memory cell 606. The upper select transistor is also referred to as a top select gate (TSG) or a DSG transistor, which includes TSG0, TSG1, TSG2 and TSG3. The lower select transistor is also referred to as a bottom select gate (BSG) or a SSG transistor.

The gate of the TSG is connected to a drain select line (DSL), the source of the TSG is connected to the drain of the first memory cell 606, and the drain of the TSG is connected to a bit line 616.

A gate of the BSG is connected to a source select line (SSL), a drain of the BSG is connected to a source of the last memory cell 606, and a source of the BSG is connected to a source line.

As shown in FIG. 7, the memory cells 606 in the memory string 608 and the memory cells 606 in the other memory strings 608 share a group of word lines 618. Assuming that each memory string 608 includes m+1 memory cells 606, the 3D semiconductor device may include m+1 WL: WL0 to WLm, m is an integer greater than 1. Each WL is connected to the memory cells 606 located in the same layer (e.g., having the same height relative to the bearing surface of the substrate). Alternatively, it may be understood that the control gates of the memory cells 606 located in the same layer and the gate connection lines between the control gates form one word line 618.

Referring back to FIG. 5, the peripheral circuit 602 may be coupled to the memory cell array 601 through bit lines (BLs) 616, word lines 618, source lines 614, SSG lines 615, and DSG lines 613. The peripheral circuit 602 may include any suitable analog, digital, and mixed-signal circuit for facilitating operations of the memory cell array 601 by applying and sensing voltage and/or current signals to and from each target memory cell 606 via a bit line 616, a word line 618, a source line 614, a SSG line 615, and a DSG line 613. The peripheral circuit 602 may include various types of peripheral circuits formed using metal-oxide-semiconductor (MOS) technology.

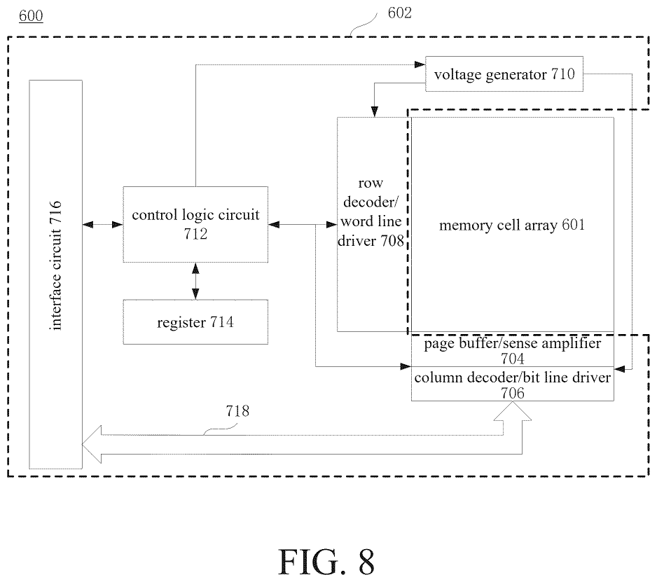

For example, FIG. 8 illustrates some exemplary peripheral circuits including a page buffer/sense amplifier 704, a column decoder/bit line driver 706, a row decoder/word line driver 708, a voltage generator 710, a control logic unit 712, a register 714, an interface circuit (I/F) 716, and a data bus 718. It should be understood that additional peripheral circuits not shown in FIG. 8 may also be included.

The page buffer/sense amplifier 704 may be configured to read and program (write) data from and to a memory cell array 601 according to control signals from the control logic unit 712. In one example, the page buffer/sense amplifier 704 may perform a program verify operation to ensure that data has been properly programmed into the memory cells 606 coupled to a selected word line 618. In yet another example, the page buffer/sense amplifier 704 may also sense a low power signal representing a data bit stored in the memory cell 606 from a bit line 616 in a read operation and amplify a small voltage swing to an identifiable logic level. As described in detail below and consistent with the scope of the present disclosure, in a program operation, the page buffer/sense amplifier 704 may include a memory module (e.g., latch, cache, register, etc.) for temporarily storing a segment of N-bit data received from the data bus 718 and providing the segment of N-bit data to a corresponding target memory cell 606 through a corresponding bit line 616 in each program pass of a multi-pass program operation using a 2^{N}-2^{N} scheme.

The column decoder/bit line driver 706 may be configured to be controlled by the control logic unit 712 and to select one or more NAND memory strings 608 by applying a bit line voltage generated by the voltage generator 710. The row decoder/word line driver 708 may be configured to be controlled by the control logic unit 712 and to select/deselect a memory block 604 of the memory cell array 601 and select/deselect word lines 618 of the memory block 604. The row decoder/word line driver 708 may also be configured to drive word lines 618 using word line voltages generated by the voltage generator 710. In some implementations, the row decoder/word line driver 708 may also select/deselect and drive SSG lines 615 and DSG lines 613. The voltage generator 710 may be configured to be controlled by the control logic unit 712 and generate word line voltages (e.g., read voltages, program voltages, pass voltages, local voltages, verify voltages, etc.), bit line voltages, and source line voltages to be provided to the memory cell array 601.

The control logic 712 may be coupled to each peripheral circuit described above and configured to control operations of each peripheral circuit. The register 714 may be coupled to the control logic unit 712 and includes a status register, a command register, and an address register for storing status information, command operation code (OP), and command addresses for controlling operations of each peripheral circuit. The interface circuit 716 may be coupled to the control logic unit 712, and act as a control buffer to buffer control commands received from the host (e.g., the host 2000 in FIG. 1) and forward them to the control logic unit 712 and to buffer status information received from the control logic unit 712 and forward it to the host. The interface circuit 716 may also be coupled to the column decoder/bit line driver 706 via a data bus 718, and act as a data input/output (I/O) interface and a data buffer to buffer and forward data to and from the memory cell array 601.

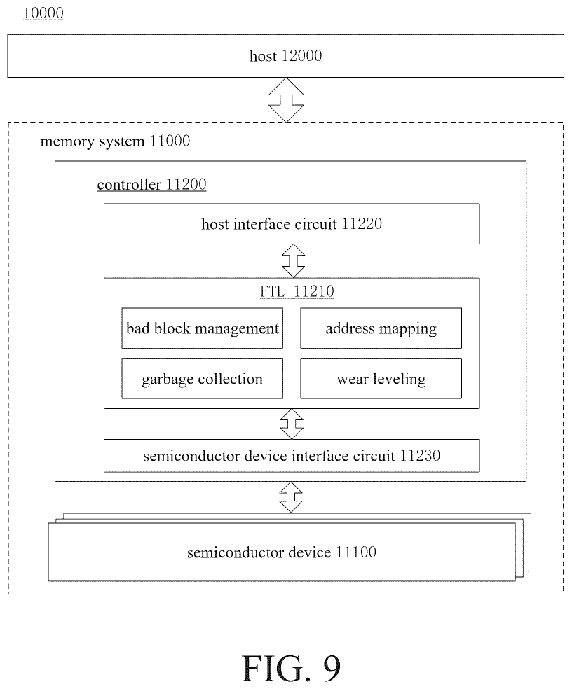

In practical applications, during manufacturing and subsequent uses of a NAND semiconductor device, to ensure stable and reliable operations of the NAND semiconductor device, the controller 11200 may be further configured to manage various functions related to data stored in or to be stored in the semiconductor device 11100, including but not limited to bad block management, garbage collection, logical-to-physical address translation, wear leveling, and the like. As shown in FIG. 9, a firmware system: a flash translation layer (FTL) 11210, may be implemented in the controller 11200. Performance, reliability, and durability of the memory system 11000 (e.g., SSD) depend on the implementation of the algorithm of the FTL 11210. At present, a complete FTL 11210 structure mainly includes address mapping, garbage collection, wear leveling, bad block management, and power failure recovery. The controller 11200 also includes a host interface circuit 11220 and a semiconductor device interface circuit 11230. The host interface circuit 11220 is configured to couple the host 12000 to the FTL 11210. The semiconductor device interface circuit 11230 is configured to couple the FTL 11210 to the semiconductor device 11100. The semiconductor device interface circuit 11230 includes a plurality of semiconductor devices 11100 (e.g., a semiconductor device 0, a semiconductor device 1, a semiconductor device 2, . . . , a semiconductor device N, etc.).

Due to the erase-before-write characteristic of the NAND Flash, for the data writing for the same logical address, updated data cannot be modified on the basis of the physical page originally storing data, and only a new physical page can be found to accommodate the updated data, therefore, firmware needs to maintain a mapping table of logical addresses to physical addresses, and continuously record correspondences between logical addresses accessed by the host and physical addresses on the NAND Flash chip. For data that has been updated, data of the original physical page becomes invalid data, which still occupies the memory space of the Flash, and if the invalid data is not processed, the space of the Flash will be quickly exhausted. In this regard, the FTL 11210 performs another important function when available space of the Flash is small: garbage collection (GC); that is, erasing invalid pages and releasing available space. The basic unit for erase is a Flash memory block, one Flash memory block contains many physical pages. Before garbage collection, the page storing valid data in a Flash memory block that is selected to be collected needs to be moved to other free memory blocks, after which the Flash memory block can be completely erased.

The Flash memory block has a certain lifetime; that is, there is an upper limit on the number of times of programs/erases that can be endured by the Flash memory block. If data writing and garbage collection are frequently performed on certain Flash memory blocks, these memory blocks can be quickly damaged, and the available space of the Flash can be reduced. When the available space is reduced to a certain threshold, the SSD will be considered damaged. In order to prolong the lifetime of the SSD, the FTL 11210 layer needs to distribute data writes and erases uniformly to each Flash memory block; that is, wear leveling. Even under the processing by the algorithm of the wear leveling, with continuous wear on the Flash memory block, a damaged Flash memory block will finally appear. The damaged Flash block may be replaced with a good Flash memory block in the over provision (OP) of the Flash, and this process is bad block management.

The bad block management mainly manages factory bad blocks (FBB) and grown bad blocks (GBB).

A factory bad block (FBB) is caused by limitations or accidental factors of manufacturing processes during the production of NAND semiconductor devices. They are identified and marked in the production phase, and when a NAND semiconductor device is used, markers within blocks in the NAND semiconductor device needs to be scanned first, bad blocks marked by a manufacturer are picked out, and a bad block table (BBT) is generated. For subsequent uses, blocks within the bad block table will not be selected to avoid causing data errors or loss at the client end.

A grown bad block (GBB), which is different from a factory bad block, is gradually formed during normal uses of a NAND semiconductor device. This is mainly because frequent erase and write operations result in physical wear on memory cells, thereby causing data read and write errors. The presence of such bad blocks is a reflection of inherent characteristics of the NAND semiconductor device technology, needs to be dynamically checked and managed through the bad block management (BBM) mechanism, where when a current memory block is detected to become a bad block, the memory block cannot be selected and used again, and is recorded into the BBT.

The bad block management includes two management policies, one is the skip policy, and the other one is the replace policy.

For the skip policy, according to an established BBT, when performing a data writing operation, a user skips a bad block registered in the table upon encountering the bad block and write a next memory block.

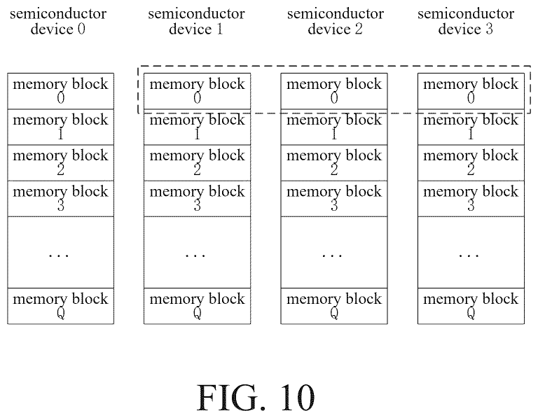

FIG. 10 illustrates four semiconductor devices (semiconductor device 0, semiconductor device 1, semiconductor device 2, and semiconductor device 3) in the memory system 11000, and stored data are sequentially written to the four semiconductor devices (semiconductor device 0, semiconductor device 1, semiconductor device 2, and semiconductor device 3). When parallel memory blocks are selected, the memory block number selected by each semiconductor device is the same, and according to a bad block table of a user, if the memory block 0 of the semiconductor device 0 is a bad block, the bad block is not added to a parallel memory block stripe, and the memory block 0 of the semiconductor device 1, the memory block 0 of the semiconductor device 2 and the memory block 0 of the semiconductor device 3 form a parallel block stripe.

For the skip policy, a bad block is skipped when encountered, the semiconductor device in which a current bad block is located is not used, and the semiconductor devices in which the remaining good memory blocks are located are used to build a parallel block.

An advantage of the skip policy is that the management is simple, and a bad block is skipped when encountered, but its disadvantage is that performance is unstable. If N semiconductor devices are concurrent, parallelism of the system may fluctuate between 1 and N, and performance may not be guaranteed to be stabilized at N concurrent dies.

For the replace policy, which is different from the skip policy, memory blocks in each die are classified into main memory blocks (main blk) and extra memory blocks (extra blk), where the extra memory blocks are configured to replace failure memory blocks in the main memory blocks. When a bad block is found on a certain die, the replace policy replaces the failure memory block in the main memory blocks with a certain good memory block in the extra memory blocks in the die. That is, under the replace policy, after encountering a failure memory block, another available free block is searched for from extra memory blocks of a current die as a replace block and a writing operation is performed on the replace block instead of skipping the die.

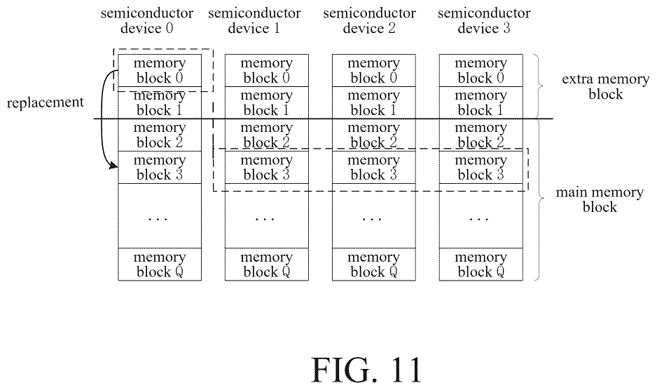

For example, FIG. 11 shows four semiconductor devices (semiconductor device 0, semiconductor device 1, semiconductor device 2, and semiconductor device 3) in the memory system 11000, and stored data are sequentially written into the four semiconductor devices (semiconductor device 0, semiconductor device 1, semiconductor device 2, and semiconductor device 3). If the memory block 3 of the semiconductor device 0 is a bad block, the failure memory block 3 of the semiconductor device 0 is replaced with the memory block 0 (or the memory block 1) in extra memory blocks in the semiconductor device 0. The memory block 0 of the semiconductor device 0, the memory block 3 of the semiconductor device 1, the memory block 3 of the semiconductor device 2, and the memory block 3 of the semiconductor device 3 then form a parallel block stripe.

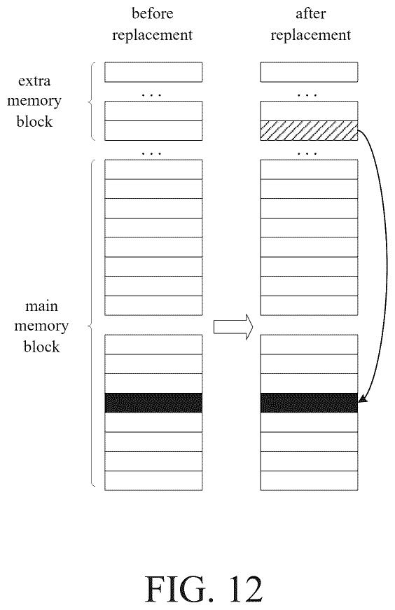

As shown in FIG. 12, a failure memory block (a black block in the figure) in main memory blocks is replaced with a memory block (a block filled with a twill in the figure) in extra memory blocks.

The replace policy exhibit significant advantages in ensuring that N dies operate simultaneously and improving performance stability. At the same time, this policy is not constrained by physical addresses, for supplementary operations of the FBB/GBB, and is able to flexibly map extra memory blocks to any location of logical address space to quickly replace damaged memory blocks.

However, although the replace policy is flexible, when a physical location of a failure memory block is far away from a physical location of a memory block used for replacement, due to parasitic resistance of semiconductor devices, a longer power supply wiring path introduces additional voltage drop, making voltage drop more severe, and significantly exacerbating a voltage drop (IR Drop) problem, which affects performance of NAND semiconductor devices.

Voltage drop, which is an inevitable voltage loss phenomenon when current passes through a resistor, is particularly critical in NAND semiconductor devices. Particularly when performing large-scale data read, write, or erase operations, current demand spikes, and varies with locations of memory cells in an array, as the parasitic resistance varies at different locations. For cells at the far end of the array, elements such as metal wires, transistors and the like inside a chip generate significant voltage loss due to a resistance effect. This voltage drop not only affects the voltage stability of each region inside a NAND semiconductor device, but also can directly weaken the overall performance and functional reliability of the chip. If the voltage drop causes insufficient voltages for data read, write, or erase operation, a corresponding operation is unsuccessful.

Further, there is a close association between a specific location of the memory block in a NAND semiconductor device and the voltage drop. Due to differences in physical layout of memory blocks at different locations, and in particular, lengths of additional wirings are different, causing changes in current distribution and the resistance effect, so that each memory block is affected differently when the voltage drop happens. Different effects for the voltage drop may finally be reflected on reduction in read/write performance of memory blocks and fluctuation of stability.

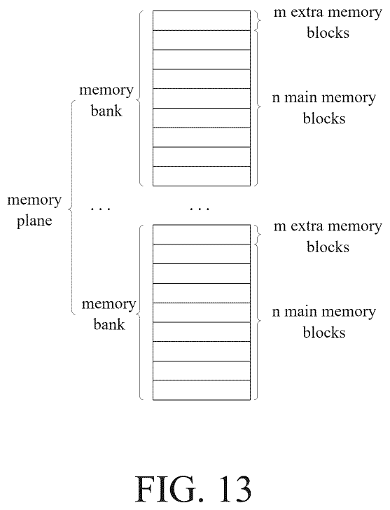

To resolve one or more of the above problems, the structure of the memory cell array 601 shown in FIG. 6 may be improved, as shown in FIG. 13, where memory blocks in a memory plane are configured into a plurality of memory banks, and at a memory bank-level, each memory bank includes m+n memory blocks, where any n of the m+n memory blocks act as main memory blocks (or working memory blocks), and each time when a corresponding operation (such as a write operation, a read operation, an erase operation, a computing-in-memory operation, and the like) is performed at a memory bank-level, n memory blocks are selected in each memory bank to perform a corresponding operation. Any m of the m+n memory blocks act as extra memory blocks to replace failure memory blocks in a memory bank, to ensure that there are at least n normal memory blocks in each memory bank, and if the number of normal memory blocks in a memory bank is less than n, the memory bank is marked as a failure memory bank and is not configured to perform a corresponding data operation.

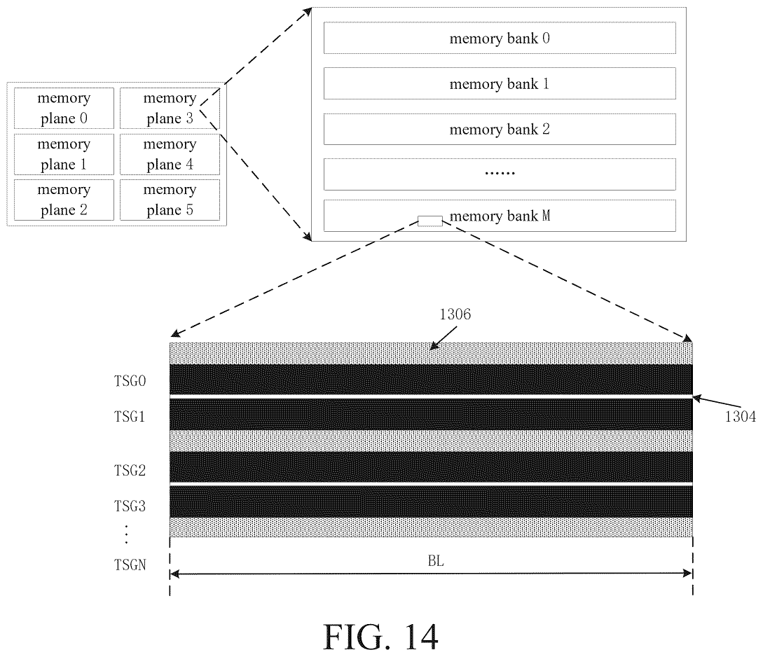

As shown in FIG. 14, six memory planes (memory plane 0, memory plane 1, memory plane 2, memory plane 3, . . . , memory plane 4, and memory 5) in a memory cell array 601 are shown, and each memory plane includes a plurality of memory banks (memory bank 0, memory bank 1, memory bank 2, . . . , memory bank M). Each memory bank includes a plurality of TSGs (TSG0, TSG1, TSG2, TSG3, . . . , TSGN). Each TSG is coupled to a gate-line of an upper select transistor of a memory string 608, and a TSG slit 1304 is formed between TSGs to cut off (or isolate) the TSGs. A gate-line slit 1306 is formed at a location adjacent to the TSG, and is configured to cut off (or isolate) a metal layer corresponding to a gate line of the upper select transistor of a memory string 608 in the memory cell array 601.

For example, a TSG may be a coarse TSG. Each memory bank may include a 16 KB bit line BL.

In order to limit the size of a relative physical location span between memory blocks in the same memory bank, when configuring memory blocks for each memory bank during design, it is ensured that a physical distance between any two of m+n memory blocks included in each memory bank is less than a threshold. Meanwhile, it is ensured that a difference between a physical address of any failure memory block and a physical address of any normal memory block in the same memory bank is less than a threshold.

In the solution disclosed in the present disclosure, in each memory bank, it is not necessary to specify which m memory blocks in a memory bank are m extra memory blocks, or which n memory blocks in the memory bank are n main memory blocks. When in use, n normal memory blocks are selected from (n+m) memory blocks in each memory bank to perform a corresponding operation. By distributing extra memory blocks into each memory bank, the relative physical location span between memory blocks in the same memory bank are relatively small, and relatively fixed, so variation of the current distribution and the resistance effect can be reduced, thereby reducing influence of voltage drop on read-write performance of the memory blocks, and improving tread-write performance, stability and reliability of the memory blocks. Meanwhile, since n working memory blocks are selected from the m+n memory blocks, corresponding data operations are relatively evenly distributed to the n memory blocks in the m+n memory blocks, so that wear leveling is achieved, and lifetime of semiconductor devices is prolonged.

For the structure of the memory cell array 601 as shown in FIG. 13, in some scenarios, if a probability that a semiconductor device generates bad blocks may be relatively small, then a probability that a plurality of memory banks all generate bad blocks will be even smaller, and if m extra memory blocks are configured for each memory bank, then utilization of memory space of the semiconductor device may be relatively low, resulting in issues such as a relatively high cost of the hardware material.

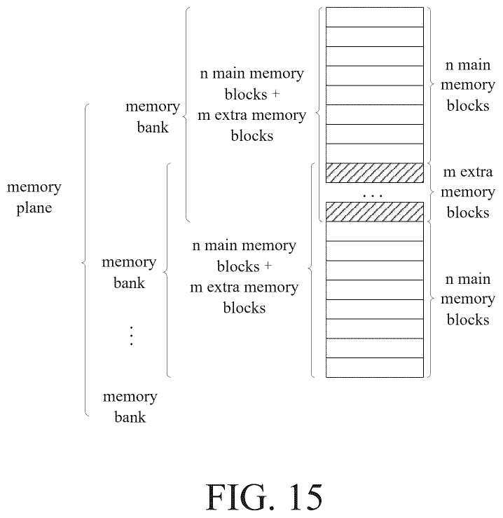

In order to improve the utilization of the memory space and reduce cost of hardware material, in some possible implementations, as shown in FIG. 15, the memory cell array 601 may be configured such that at least two memory banks share m extra memory blocks (m is greater than or equal to 1). Any one of the m extra memory blocks can only be configured to replace a failure memory block in one memory bank at the same time.

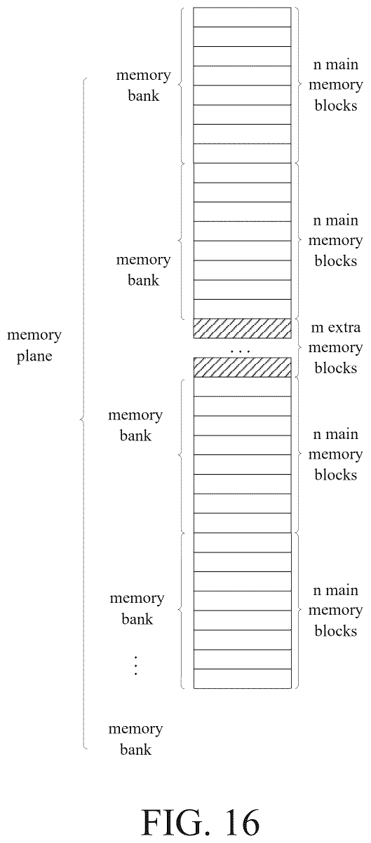

In some examples, as shown in FIG. 16, the memory cell array 601 may be configured such that four memory banks share m extra memory blocks. Each memory bank includes n main memory blocks.

In order to accurately determine a relative physical location of extra memory blocks at a memory bank-level (that is, no selected memory block spans memory banks), address decoding (X-Dec) is performed in a two-level decoding manner of a memory bank-level and a memory block-level.

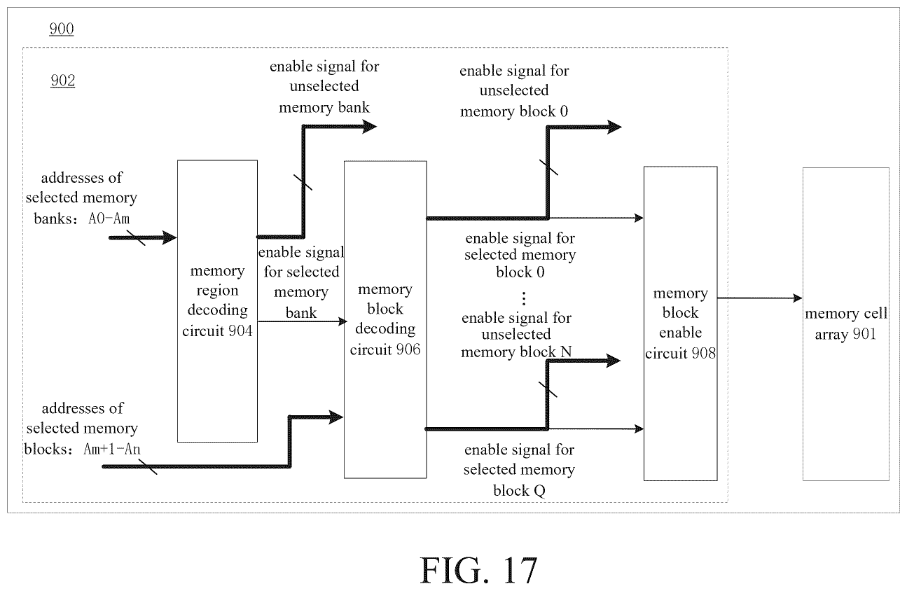

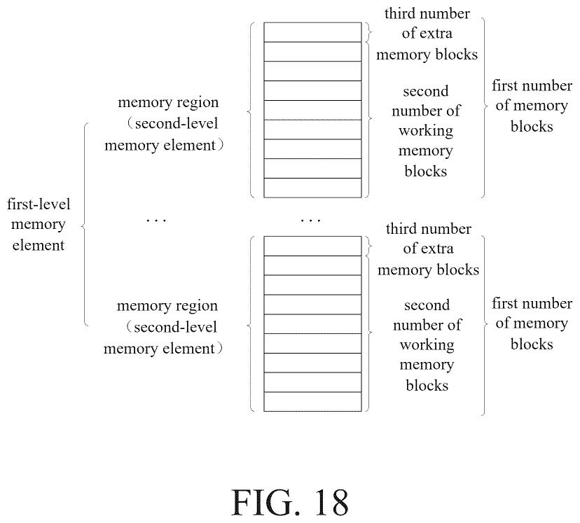

FIG. 17 shows a schematic structural diagram of a semiconductor device 900, where the semiconductor device 900 includes a peripheral circuit 902 and a memory cell array 901, and the peripheral circuit 902 is coupled to the memory cell array 901. The peripheral circuit 902 includes a memory region decoding circuit 904, a memory block decoding circuit 906, and a memory block enable circuit 908 coupled in sequence. As shown in FIG. 18, the memory cell array 901 includes a plurality of first-level memory elements (planes) each including a plurality of memory blocks. The plurality of memory blocks are configured in a plurality of memory regions, where a memory region acts as a second-level memory element (bank), and each memory region (or a second-level memory element, the following description using the memory region as an example) includes a first number of memory blocks. A second number of memory blocks in the first number of memory blocks act as working memory blocks. The second number is less than the first number.

As shown in FIG. 18, a third number of memory blocks in the first number of memory blocks in a memory region (or a second-level memory element) act as extra memory blocks, and a sum of the second number and the third number is equal to the first number.

In some examples, the memory region (or the second-level memory element) may be a memory bank shown in FIG. 13, FIG. 14, FIG. 15, and FIG. 16, the third number of extra memory blocks in FIG. 18 may be m extra memory blocks as shown in FIG. 13, the second number of working memory blocks may be n main memory blocks shown in FIG. 13, and the first number of memory blocks may be m+n memory blocks (a sum of m extra memory blocks and n main memory blocks) as shown in FIG. 13.

In some other examples, at least two of the plurality of memory regions share the third number of extra memory blocks. For example, a memory region (or a second-level memory element) may be a memory bank shown in FIG. 15 and FIG. 16, the third number of extra memory blocks in FIG. 18 may be at least one of m extra memory blocks shown in FIG. 15 or FIG. 16, and the second number of working memory blocks may be n main memory blocks shown in FIG. 15 or FIG. 16.

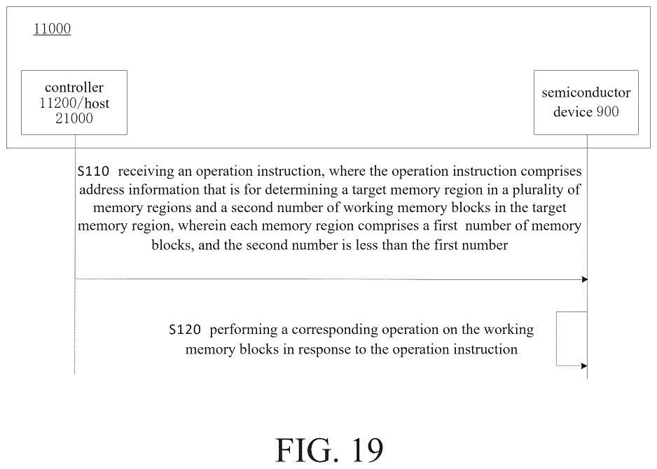

Based on the semiconductor device 900 shown in FIG. 17 and the memory cell array 901 shown in FIG. 18, the semiconductor device 900 may implement an operating method including, e.g., operations S110 and S120, as shown in FIG. 19.

Referring to FIG. 19, at S110, the operations may include receiving an operation instruction, where the operation instruction includes address information for determining a target memory region in a plurality of memory regions and a second number of working memory blocks in the target memory region. Each memory region includes a first number of memory blocks. The second number is less than a first number.

In some examples, the operation instruction may be sent by the controller 11200 as in FIG. 1, FIG. 3, and FIG. 4 or the host 21000 as in FIG. 2, and the semiconductor device (the semiconductor device as shown in FIGS. 1, FIG. 2, FIG. 3, and FIG. 4) receives the operation instruction. The operation instruction includes the address information for determining the target memory region (that is, a selected memory bank) in the plurality of memory regions and the second number of working memory blocks (n main memory blocks shown in FIG. 13) in the target memory region. The second number (n main memory blocks) is less than the first number (m+n memory blocks).

In some examples, the address information may include A0-Am and Am+1-An. A0-Am representing the target memory region, that is, addresses of selected memory banks, and addresses A0-Am of the selected memory banks are parsed by the memory region decoding circuit 904 for memory banks. Am+1-An represent working memory blocks; that is, addresses of selected memory blocks, and the addresses Am+1-An of the selected memory blocks are parsed by the memory block decoding circuit 906, to ensure that the selected memory blocks are memory blocks in the same memory bank.

The memory region decoding circuit 904 receives address signals for selected memory banks A0-Am from the outside and selects one or more memory banks to access according to the address signals. Enable signals for selected memory banks are sent to the memory block decoding circuit 906, and when an enable signal for a selected memory bank is activated, it allows data in the memory bank to be accessed.

The memory block decoding circuit 906 receives address signals for selected memory blocks (Am+1-An) from the outside, selects a memory block in a selected memory bank according to an address signal for a selected memory block, and sends an enable signal to the selected memory block in the memory cell array 901 through the memory block enable circuit 908 to activate the selected memory block. For example, the memory block 0 (or the memory block Q) in a current memory bank is selected, and the memory block 0 (or the memory block Q) in another memory bank is not selected.

In FIG. 17, selected memory banks and selected memory blocks represent memory banks and memory blocks that are selected based on controls by the memory region decoding circuit 904, the memory block decoding circuit 906 and the memory block enable circuit 908, and enable signals described above. These selected memory banks and memory blocks may then perform corresponding data operations (e.g., data read, data write, data erase, and computing-in-memory operations). Unselected memory banks and unselected memory blocks means remaining in an inactive state and not participating in performing corresponding data operations without corresponding enable signals.

In some examples, if the first number of memory blocks include the third number of failure memory blocks, and the sum of the second number and the third number is equal to the first number (e.g., all extra memory blocks preconfigured in a target memory region or a target memory bank are configured to replace the failure memory blocks), then only the minimum number of memory blocks required for performing a corresponding operation are left in the target memory region, for example, if the minimum n memory blocks are required for performing the corresponding operation, then only n normal memory blocks are left in the target memory region. If a peripheral circuit receives a plurality of operation instructions, and target memory regions indicated by the plurality of operation instructions are all the same, then a second number of working memory blocks in the target memory region that are configured to perform the corresponding operation are the same.

For example, the peripheral circuit 902 receives a first operation instruction and a second operation instruction. Address information in the first operation instruction and address information in the second operation instruction are for determining the same memory region in a plurality of memory regions and a second number of working memory blocks in the same memory region. The peripheral circuit 902 performs a corresponding operation on the second number of working memory blocks in response to the first operation instruction and the second operation instruction.

In some examples, the first number of memory blocks include a fourth number of failure memory blocks. The sum of the fourth number and the second number is less than the first number. That is, only a portion of extra memory blocks preconfigured in a target memory region or a target memory bank are configured to replace the failure memory blocks, and the number of remaining normal memory blocks in the target memory region is greater than the second number. If the number of normal memory blocks is a fifth number, the second number of memory blocks in the fifth number of normal memory blocks act as the working memory blocks. The sum of the fifth number and the fourth number is equal to the first number.

For example, the peripheral circuit 902 receives a first operation instruction and a second operation instruction. Address information in the first operation instruction is for determining a first memory region in a plurality of memory regions and a second number of working memory blocks in the first memory region. The second operation instruction is for determining a second memory region in the plurality of memory regions and a second number of working memory blocks in the second memory region. When the first memory region and the second memory region are the same memory region, the second number of working memory blocks in the first memory region are different from the second number of working memory blocks in the second memory region.

In some examples, in each memory region, a physical distance between any two memory blocks in the first number of memory blocks is less than a threshold. Similar to implementations shown in FIG. 13, FIG. 15, and FIG. 16, in order to limit the magnitude of a relative physical location span between memory block blocks in the same memory bank, when configuring memory blocks for each memory bank during design, it is ensured that a physical distance between any two of m+n memory block blocks included in each memory bank is less than a threshold.

For example, the first number of memory blocks include a sixth number of failure memory blocks. A difference between a physical address of any failure memory block in the sixth number of failure memory blocks and a physical address of any normal memory block in a seventh number of normal memory blocks is less than a preset threshold. Similar to implementations shown in FIG. 13, FIG. 15, and FIG. 16, a difference between a physical address of any failure memory block and a physical address of any normal memory block in the same memory bank may also be defined to be less than a threshold.

Referring again to FIG. 19, at S120, the operations may include performing a corresponding operation on the working memory blocks in response to the operation instruction.

In some examples, the corresponding operation may include, but are not limited to, writing stored data to a target memory region, reading stored data from a target memory region, and erasing stored data in a target memory region.

The semiconductor device in implementations corresponding to FIG. 13, FIG. 15, FIG. 16, FIG. 17, and FIG. 18 may be applied to a compute-in-memory device.

At present, most computing platforms are based on a von Neumann's architecture, where a von's architecture is compute-centric, where a computation module and a memory module are separated, and the two modules coordinate to complete data operation and access. However, because the computation module (for example, the processor) is designed to mainly improve the computation speed, while the memory module is more focus on capacity improvement and cost optimization, so performance mismatch occurs between “memory” and “computation”, which leads to problems such as low memory access bandwidth, long latency, high power consumption and the like, that is, commonly referred “memory wall” and “power consumption wall”. The more intensive the memory accesses, the more serious the problem of “wall”, and the more difficulty to increase the computing power. With the rapid rise of memory access intensive applications represented by artificial intelligence, such as a convolutional neural network (CNN), a recurrent neural network (RNN), and the like, memory access latency and power consumption overhead cannot be ignored, and the reformation of the computing architecture is particularly urgent.

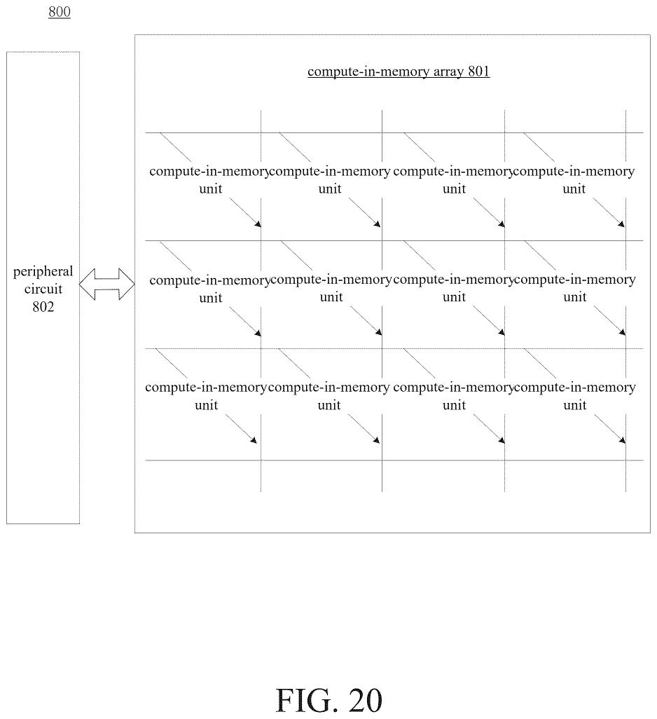

The core of the compute-in-memory (CIM) architecture, which is a new computing architecture, is to fully fuse memory and computation, and the bottleneck of the von Neumann's architecture can be effectively overcome, and increase in computational energy efficiency by an order of magnitude can be achieved. For the compute-in-memory, in the chip design process, the memory cell and the computation unit are no longer distinguished, and the fusion of memory and computation is truly realized. The essence of the compute-in-memory is to utilize physical characteristics of different storage media to redesign memory circuits to have both computing and memory capabilities, thereby directly eliminating the boundary between “memory” and “compute”, and achieving the goal of improving computational energy efficiency by an order of magnitude. FIG. 20 shows a structural diagram of a compute-in-memory device, the compute-in-memory device 800 includes a compute-in-memory array 801 and a peripheral circuit 802, and the compute-in-memory array 801 is coupled to the peripheral circuit 802. The compute-in-memory array 801 is configured to store weight matrix data, where the compute-in-memory array includes memory cells arranged in rows and columns, where these cells may perform various computation operations, such as a matrix operation and a vector operation, according to a preset algorithm.

Compared with the von Neumann's architecture, the compute-in-memory architecture has the advantages of high operation speed, low power consumption, high integration density and the like. The compute-in-memory fuses the computation function into the memory cell, so the frequent migration of data between the data memory module and the computation module is reduced, and the delay of data transmission is also reduced. In addition, the compute-in-memory integrates the computation and memory functions on the same chip, so requirements for external connections and wirings are reduced, so that chip integration is higher, and chips can be applied to smaller and lighter electronic devices.

An artificial intelligence algorithm represented by a neural network relates to various tensor and vector computation, where most representative operators are matrix vector multiplication; and these operators have the characteristics of large data volume, large computation volume and high parallelism requirement. When a processor in a computing platform based on the von Neumann's architecture executes an artificial intelligence algorithm, due to the separation of memory and computation, a large amount of data migration exists between the memory and the arithmetic unit, causing huge power consumption and delay overhead, which results in that the power consumption for data migration is far higher than the power consumption for computation; and this becomes a bottleneck of the development of the von Neumann's architecture accelerator. The core idea of the compute-in-memory technology is to fuse the memory with the arithmetic unit together, where by storing relatively fixed weight matrix data in the memory and inputting input feature vector into the array, the matrix-vector multiplication computation is performed in the memory, so migration of a large amount of weight data is effectively avoided while high parallel data access and computation are completed, thereby achieving a purpose of improving the operation speed and the energy efficiency. Therefore, the compute-in-memory is very suitable for accelerating matrix and vector operations in artificial intelligence algorithms.

In some examples, the compute-in-memory array 801 may be configured to perform a matrix-vector multiplication operation as shown in the equation (1), where V_{IN0}, V_{IN1}, . . . , V_{INN} represent operation data (or input vector) input into the compute-in-memory array 801, where taking image recognition applications as an example, the operation data may be image feature information. w₀₀, w₀₁, . . . , w_{0M}; w₁₀, w₁, . . . , w_{1M}; . . . ; w_{N0}, w_{N1}, . . . , w_{NM} etc. represent weight matrix data stored in the compute-in-memory array 801, where the weight matrix data is composed of weight data (for example, for a flash memory, NAND or NOR can be characterized by threshold voltages of memory cells, and for a RRAM memory, NAND or NOR can be characterized by conductance of memory cells, and this example takes NAND as an example for illustration). Equations (2), (3) and (4) are used to represent operation results of multiplying and accumulating the operation data and the weight matrix data.

$$[ {V}_{IN 0} , {V}_{IN 1} , … , {V}_{INN} ] * [ \begin{matrix}{w}_{00 ,} {w}_{01} , … , {w}_{0 M} \\ {w}_{10 ,} {w}_{11} , … , {w}_{1 M} \\ … \\ {w}_{N 0 ,} {w}_{N 1} , … , {w}_{NM}\end{matrix} ] = [ {I}_{D 0} , {I}_{D 1} , … , {I}_{DM} ] \qquad equation ( 1 )$$

$${I}_{D 0} = {V}_{IN 0} * {w}_{00} + {V}_{IN 1} * {w}_{10} + … + {V}_{INN} * {w}_{N 0} \qquad equation ( 2 )$$

$${I}_{D 1} = {V}_{IN 0} * {w}_{01} + {V}_{IN 1} * {w}_{11} + … + {V}_{INN} * {w}_{N 1} \qquad equation ( 3 )$$

$$…$$

$${I}_{DM} = {V}_{IN 0} * {w}_{0 M} + {V}_{IN 1} * {w}_{1 M} + … + {V}_{INN} * {w}_{NM} \qquad equation ( 4 )$$

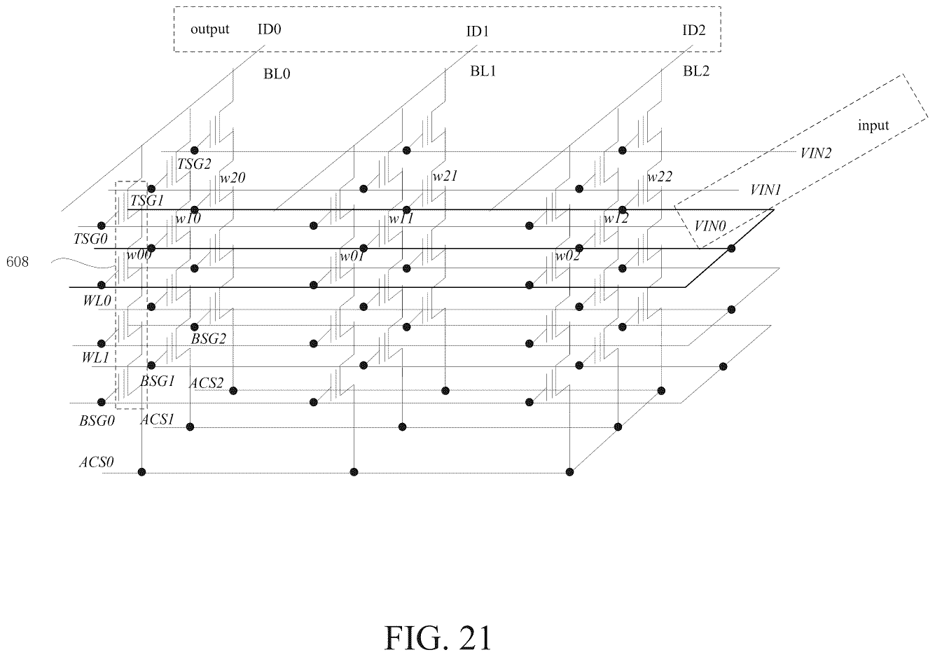

FIG. 21 shows an example of a matrix-vector operation when the semiconductor device 600 is used as the compute-in-memory device 800, as shown in equation (5) to equation (9):

$$[ {V}_{IN 0} {V}_{IN 1} {V}_{IN 2} ] * [ \begin{matrix}{w}_{00} & {w}_{01} & {w}_{02} \\ {w}_{10} & {w}_{11} & {w}_{12} \\ {w}_{20} & {w}_{21} & {w}_{22}\end{matrix} ] = [ {I}_{D 0} {I}_{D 1} {I}_{D 2} ] \qquad equation ( 5 )$$

$${I}_{D 0} = {V}_{IN 0} * {w}_{00} + {V}_{IN 1} * {w}_{10} + {V}_{IN 2} * {w}_{20} \qquad equation ( 6 )$$

$${I}_{D 1} = {V}_{IN 1} * {w}_{01} + {V}_{IN 1} * {w}_{10} + {V}_{IN 1} * {w}_{20} \qquad equation ( 7 )$$

$${I}_{D 2} = {V}_{IN 0} * {w}_{02} + {V}_{IN 1} * {w}_{12} + {V}_{IN 2} * {w}_{22} \qquad equation ( 8 )$$

where the process of writing weight data w₀₀, w₀₁, w₀₂; w₁₀, w₁₁, w₁₂; w₂₀, w₂₁, w₂₂ into the semiconductor device 600 is completely consistent with the program process of the memory cell array 601. Operation data (or input vector) V_{IN0}, V_{IN1}, V_{IN2} are input to gates of TSG0, TSG1, TSG2 respectively, and operation data (output data or output vector) I_{D0}, I_{D1}, I_{D2} are output from bit lines BL0, BL1 and BL2 respectively.

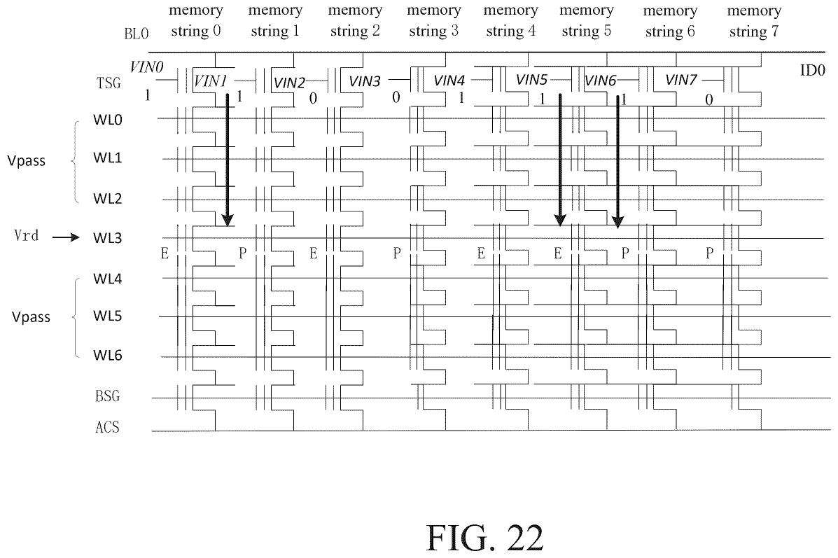

FIG. 22 shows a basic principle of a computing-in-memory operation, as shown in FIG. 22, seven word lines WL of WL0, WL1, WL2, WL3, WL4, WL5, and WL6 in the memory cell array 601, and eight memory strings (str) of memory string 0 (str0), memory string 1 (str1), memory string 2 (str2), memory string 3 (str3), memory string 4 (str4), memory string 5 (str5), memory string 6 (str6), and memory string 7 (str7) are shown.

A memory cell may be, but is not limited to, configured to be a SLC, MLC, TLC and QLC memory cell. This example takes the memory cell for storing weight array data being configured to be an SLC memory cell as an example, that is, each memory cell may have two states, an erase state E, or a program state P. The erase state E may indicate that data stored in a current memory cell is 1, denoted as E (1). The program state P may indicate that data stored in a current memory cell is 0, denoted as P (0).

As shown in Table 1, relationship between input operation data (Vin), weight data in memory cells (weights, threshold voltages Vth of the memory cells, etc.), and operation results (such as bit line (BL) current) output by the memory cell array 601 is shown.

TABLE 1

| Operation Data | Weight Data | Operation Results |
|---|---|---|
| (Vin) | (weight) | (output) |
| 1 | E(1) | 1 |
| 1 | P(0) | 0 |
| 0 | E(1) | 0 |
| 0 | P(0) | 0 |

During an in-memory computing operation, a read voltage Vrd is applied on a selected word line WL (a program word line, memory cells on which stores weight data) to activate weight data stored in the memory cells coupled to the selected word line WL, and a turn-on voltage Vpass is applied to the other WLs. Input voltages (operation data or input vectors) is applied on top select gates TSGs. Output current is collected at the BL end, and after output current of all the memory cells are collected, addition is achieved through accumulation.

For example, as shown in FIG. 22, taking weight data stored in memory cells of word line WL3 being E (1), P (0), E (1), P (0), E (1), E (1), P (0), and P (0) as an example. If a read voltage Vrd is applied to the word line WL3 in the memory cell array 601 as shown in FIG. 22, and input voltages V_{IN0}=1, V_{IN1}=1, V_{IN2}=0, V_{IN3}=0, V_{IN4}=1, V_{IN5}=1, V_{IN6}=1, V_{IN7}=1 are applied to the top select gates TSG, then

$${I}_{D 0} = 1 * E ( 1 ) + 1 * P ( 0 ) + 1 * E ( 1 ) + 1 * P ( 0 ) + 1 * E ( 1 ) + 1 * E ( 1 ) + 1 * P ( 0 ) + 1 * P ( 0 )$$

Therefore, the process of performing a vector-matrix multiplication and accumulation operation by a compute-in-memory device is equivalent to the operation of reading current when given a voltage in the memory cell array 601. The memory string 0, memory string 4, and memory string 5 contribute currents in the current I_{D0}.

A small fluctuation of the voltage during in-memory computing in the compute-in-memory device may cause a deviation of computation results, especially in an in-memory computing scenario that requires high accuracy. In view of strict requirements for the accuracy of the in-memory computing on the voltage drop (IR Drop), the semiconductor device in implementations corresponding to FIG. 13, FIG. 15, FIG. 16, FIG. 17, and FIG. 18 may be applied to a compute-in-memory device, so as to reduce the influence of the voltage drop on the accuracy of the in-memory computing.

In the schematic diagram of the semiconductor device shown in FIG. 17, when memory blocks in the semiconductor device 900 are configured for a normal memory operation (for example, data write, data read, or data erase), only one memory block needs to be selected for operation each time. However, when memory blocks in the semiconductor device 900 are configured to perform an in-memory computing operation, a plurality of memory blocks need to be selected each time (because operation data received by one memory block is limited). Addresses for selected memory blocks include addresses of the plurality of memory blocks, and the memory block decoding circuit 906 needs to perform decoding for multiple times, and outputs a plurality of high-level memory block enable signals to activate the selected memory blocks. Therefore, when memory blocks in the semiconductor device 900 are configured to perform a computing-in-memory operation, circuit requirements are complex, operations are inconvenient, and power consumption is large.

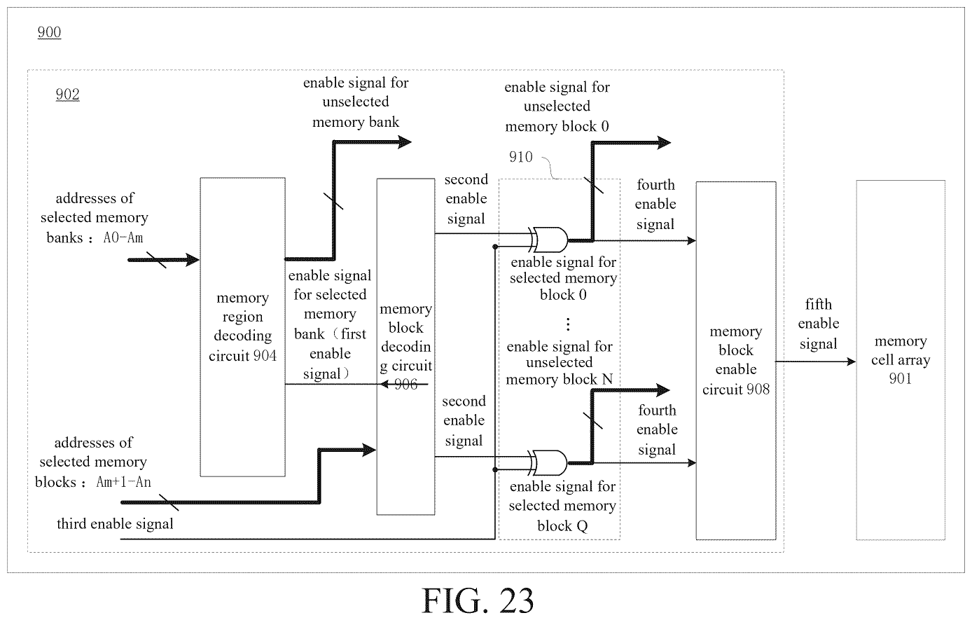

In order to reduce complexity and power consumption of circuits and facilitate operations, the present disclosure improves the circuit shown in FIG. 17, as shown in FIG. 23. In the semiconductor device 900 as shown in FIG. 23, an XOR logic circuit 910 is added to reduce complexity and power consumption of circuits, and to achieve flexible selection of a plurality of memory banks by performing a reverse selection operation of the XOR logic circuit 910. In an implementation, memory blocks are controlled to perform normal memory operations or perform computing-in-memory operations by in-memory computing enable signals.

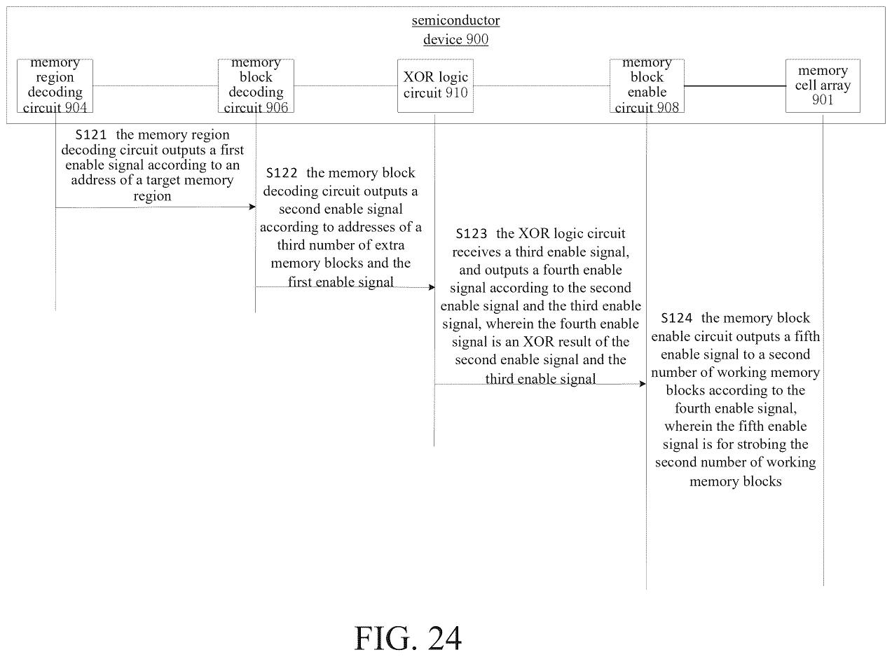

In some possible implementations, taking the first number of memory blocks including a third number of extra memory blocks, a sum of the second number and the third number is equal to the first number, and the address information including the address of the target memory region and the addresses of the third number of extra memory blocks as an example. The semiconductor device 900 shown in FIG. 23 may implement operating method including the operations S121, S122, S123, and S124, as shown in FIG. 24.

Referring to FIG. 24, at S121, the operations may include the memory region decoding circuit outputs a first enable signal according to the address of the target memory region.

For example, the memory region decoding circuit 904 outputs the first enable signal (i.e., an enable signal of a selected memory bank) according to the address of the target memory region (i.e., the address of the selected memory bank: A0-Am).

At S122, the memory block decoding circuit outputs a second enable signal according to the addresses of the third number of extra memory blocks and the first enable signal.

At S123, the XOR logic circuit receives a third enable signal, and outputs a fourth enable signal according to the second enable signal and the third enable signal. The fourth enable signal is an XOR result of the second enable signal and the third enable signal.

In some example, the third enable signal may be carried in operation instruction, and may be sent by the controller 11200 shown in FIG. 1, FIG. 3, or FIG. 4, or the host 21000 shown in FIG. 2, and the controller 11200 or the host 21000 can control the voltage level of the third enable signal to control the semiconductor device 900 shown in FIG. 23 to perform a different operation (data write, data read, data erase, or in-memory computing).

In an example, if the third enable signal is at a low level, the memory block performs a normal memory operation. At this time, the memory block decoding circuit 906 outputs a high level enable signal to a selected memory block, and after the high level enable signal passes through the XOR logic circuit 910, the XOR logic circuit 910 outputs a high level, and the selected memory block is activated for a normal memory operation (data write, data read or data erase).

For example, the operation instruction can include a sixth enable signal (an enable signal when the third enable signal is at a low level). The sixth enable signal is for indicating that the target memory region is configured to perform a data memory operation. The data memory operation may include, but is not limited to, writing stored data to the target memory region, reading stored data from the target memory region, and erasing stored data in the target memory region.

In another example, if the third enable signal is at a high level, the XOR logic circuit 910 implements a reverse selection operation, and the memory block performs a computing-in-memory operation. At this time, the memory block decoding circuit 906 outputs a high level enable signal to the selected memory block, and after the high level enable signal passes through the XOR logic circuit 910, the XOR logic circuit 910 outputs a low level, and the selected memory block is in an inactive state, while unselected memory blocks are in an active state for a computing-in-memory operation.

For example, the operation instruction further includes a seventh enable signal (an enable signal when the third enable signal is at a high level). The seventh enable signal is for indicating that the target memory region is configured to perform a computing-in-memory (in-memory computing) operation. In implementations as shown in FIG. 20, FIG. 21, and FIG. 22, in response to the operation instruction, the peripheral circuit inputs operation data to the second number of working memory blocks to obtain an operation result. The operation result is an operation result of the operation data and data stored in the working memory blocks.

In the above implementation, both the second enable signal and the third enable signal are at a high level, and after they pass through the XOR logic circuit 910, the fourth enable signal output by the XOR logic circuit 910 is at a low level, the selected third number of extra memory blocks (which may include failure memory blocks) are in an inactive state, and the unselected second number of working memory blocks are in an active state for performing corresponding operations. The number of the third number of extra memory blocks is less than the number of the second number of working memory blocks, and control logics of the semiconductor device 900 shown in FIG. 23 is simplified by the reverse selection operation of the XOR logic circuit 910.

At S124, the memory block enable circuit outputs a fifth enable signal to the second number of working memory blocks according to the fourth enable signal. The fifth enable signal is for strobing the second number of working memory blocks.

For example, as shown in FIG. 21 and FIG. 22, the working memory blocks include select lines (for example, TSGs) and memory strings. A memory string includes a plurality of transistors, where drain lines and source lines of the plurality of transistors are alternately coupled to each other, and a select line is coupled to a gate line of a transistor at one end of the memory string. In response to the operation instruction, the peripheral circuit inputs operation data (for example, V_{IN0}=1, V_{IN1}=1, V_{IN2}=0, V_{IN3}=0, V_{IN4}=1, V_{IN5}=1, V_{IN6}=1, V_{IN7}=1) to select lines in the working memory blocks to obtain an operation result, as follow:

$${I}_{D 0} = 1 * E ( 1 ) + 1 * P ( 0 ) + 1 * E ( 1 ) + 1 * P ( 0 ) + 1 * E ( 1 ) + 1 * E ( 1 ) + 1 * P ( 0 ) + 1 * P ( 0 )$$

In the above implementations, the semiconductor device 900 as shown in FIG. 23 can simplify the circuit structure and the control logics of the semiconductor device 900 by the reverse selection operation of the XOR logic circuit 910, thereby reducing power consumption of circuits, and achieving a flexible selection of multiple memory banks.

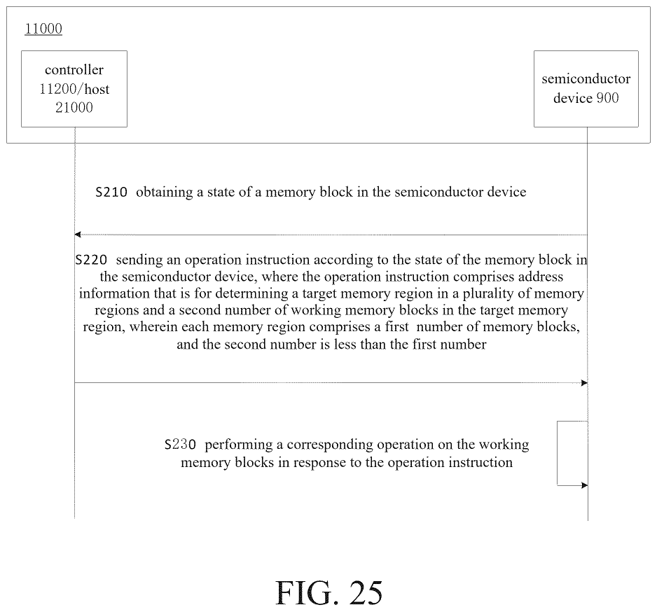

Based on the semiconductor device, the system and the electronic device in implementations corresponding to FIG. 1, FIG. 2, FIG. 3, FIG. 4, FIG. 5, FIG. 6, FIG. 7, FIG. 8, FIG. 9, FIG. 13, FIG. 14, FIG. 15, FIG. 16, FIG. 17, FIG. 18, FIG. 20, FIG. 21, FIG. 22, and FIG. 23, a method including the following operations S210, S220, and S230 as shown in FIG. 25 may be implemented.

Referring to FIG. 25, at S210, the operations may include obtaining a state of a memory block in the semiconductor device.

In some examples, the controller obtains a state of a memory block in the semiconductor device, where the state of the memory block in the semiconductor device includes a failure state and a normal state. For example, for factory bad blocks, the FTL algorithm needs to identify and manage these bad blocks. When the flash memory is used, it is first necessary to scan markers in memory blocks in the semiconductor device, pick bad blocks or failure memory blocks marked by the manufacturer, and generate a bad block table (BBT). For subsequent uses, blocks within the bad block table will not be selected. For grown bad blocks (GBB): with the use of a semiconductor device, with the wear of the semiconductor device, some good blocks also become bad blocks during usage.

There are mainly the following cases: (1) When a flash block is erased, the bus returns to an erase failure state. (2) When a flash page is written, the bus returns to a write failure state. (3) When any data page in a block is read, if there are too many data errors and the ECC range is exceeded, the data errors still cannot be uncorrectable after various error mitigation. When any one of the above three cases occurs, it is considered that a current memory block becomes a failure memory block, and the block cannot be selected for use any more. The number of the block is stored in the BBT.

Referring again to FIG. 25, at S220, the operations may include sending an operation instruction according to the state of the memory block in the semiconductor device, where the operation instruction includes address information for determining a target memory region in a plurality of memory regions and a second number of working memory blocks in the target memory region. Each memory region includes a first number of memory blocks. The second number is less than the first number.

In some examples, the operation instruction is sent by the controller 11200 as shown in FIG. 1, FIG. 2, and FIG. 4 or the host 21000 as shown in FIG. 2.

Referring again to FIG. 25, at S230, the operations may include performing a corresponding operation on the working memory blocks in response to the operation instruction.

In some examples, the semiconductor device (the semiconductor device as shown in FIG. 1, FIG. 2, FIG. 3, or FIG. 4) receives and responds to the operation instruction. For the execution process of step S230, refer to operations S110-S120 and steps S121-S124, and details are not described herein again.

An example of the present disclosure further provides a computer-readable storage medium including instructions. The instructions, when executed on the electronic device or the memory system recited in the above examples, cause the electronic device or the memory system to perform the method of operating the semiconductor device recited in the above examples.

An example of the present disclosure further provides a system, including the controller as shown in FIG. 1, FIG. 2, or FIG. 4, and the semiconductor device as shown in FIG. 1, FIG. 2, FIG. 3, or FIG. 4.

The above descriptions are only specific implementations of the present disclosure, but the protection scope of the present disclosure is not limited thereto, and changes or replacements that may be easily conceived by any person skilled in the art within the technical scope of the present disclosure should be covered within the protection scope of the present disclosure. Therefore, the protection scope of the present disclosure should be defined by the protection scope of the claims.

What is claimed is:

1. A semiconductor device, comprising:
a peripheral circuit; and
a memory cell array;
wherein the peripheral circuit is coupled to the memory cell array, the memory cell array comprises a plurality of memory regions, and each memory region comprises a first number of memory blocks; and
wherein the peripheral circuit is configured to:
receive an operation instruction, wherein the operation instruction comprises address information for determining a target memory region in the plurality of memory regions and a second number of working memory blocks in the target memory region, and the second number is less than the first number; and
perform a corresponding operation on the working memory blocks in response to the operation instruction.

2. The semiconductor device of claim 1, wherein a third number of memory blocks in the first number of memory blocks act as extra memory blocks, and a sum of the second number and the third number is equal to the first number.

3. The semiconductor device of claim 1, wherein:
the first number of memory blocks comprise a third number of failure memory blocks;
a sum of the second number and the third number is equal to the first number; and
the peripheral circuit is configured to:
receive a first operation instruction and a second operation instruction, wherein address information in the first operation instruction and address information in the second operation instruction are for determining the same memory region in the plurality of memory regions and the second number of working memory blocks in the same memory region; and
perform a corresponding operation on the second number of working memory blocks in response to the first operation instruction and the second operation instruction.

4. The semiconductor device of claim 1, wherein:
the first number of memory blocks comprise a fourth number of failure memory blocks, and a sum of the fourth number and the second number is less than the first number; and
the second number of memory blocks in a fifth number of normal memory blocks act as working memory blocks, and a sum of the fifth number and the fourth number is equal to the first number.

5. The semiconductor device of claim 4, wherein:
a plurality of operation instructions comprise a first operation instruction and a second operation instruction;
the address information in the first operation instruction is for determining a first memory region in the plurality of memory regions and the second number of working memory blocks in the first memory region;
the second operation instruction is for determining a second memory region in the plurality of memory regions and the second number of working memory blocks in the second memory region; and
when the first memory region and the second memory region are the same memory region, the second number of working memory blocks in the first memory region are different from the second number of working memory blocks in the second memory region.

6. The semiconductor device of claim 1, wherein
the first number of memory blocks comprise a sixth number of failure memory blocks;
a difference between a physical address of any failure memory block in the sixth number of failure memory blocks and a physical address of any normal memory block in a seventh number of normal memory blocks is less than a preset threshold; and
a sum of the sixth number and the seventh number is equal to the first number.

7. The semiconductor device of claim 1, wherein in each memory region, a physical distance between any two memory blocks in the first number of memory blocks is less than a threshold.

8. The semiconductor device of claim 2, wherein the address information comprises an address of the target memory region and addresses of the third number of extra memory blocks.

9. The semiconductor device of claim 1, wherein the peripheral circuit comprises a memory region decoding circuit, a memory block decoding circuit, an XOR logic circuit, and a memory block enable circuit coupled in sequence.

10. The semiconductor device of claim 9, wherein:
the first number of memory blocks comprise a third number of extra memory blocks, a sum of the second number and the third number is equal to the first number, and the address information comprises an address of the target memory region and addresses of the third number of extra memory blocks;
the memory region decoding circuit is configured to output a first enable signal according to the address of the target memory region;
the memory block decoding circuit is configured to output a second enable signal according to the addresses of the third number of extra memory blocks and the first enable signal;
the XOR logic circuit is configured to receive a third enable signal, and output a fourth enable signal according to the second enable signal and the third enable signal;
the fourth enable signal is an XOR result of the second enable signal and the third enable signal;
the memory block enable circuit is configured to output a fifth enable signal to the second number of working memory blocks according to the fourth enable signal; and
the fifth enable signal is for strobing the second number of working memory blocks.

11. The semiconductor device of claim 2, wherein at least two of the plurality of memory regions share the third number of extra memory blocks.

12. The semiconductor device of claim 1, wherein:
the operation instruction further comprises a sixth enable signal;
the sixth enable signal is for indicating that the target memory region is configured to perform a data storage operation; and
the peripheral circuit is further configured to:
write stored data to the target memory region in response to the operation instruction;
read stored data from the target memory region in response to the operation instruction; or
erase stored data in the target memory region in response to the operation instruction.

13. The semiconductor device of claim 1, wherein:
the operation instruction further comprises a seventh enable signal;
the seventh enable signal is for indicating that the target memory region is configured to perform a computing-in-memory operation;
the peripheral circuit is configured to input operation data to the second number of working memory blocks to obtain an operation result in response to the operation instruction; and
the operation result is an operation result of the operation data and data stored in the working memory blocks.

14. The semiconductor device of claim 13, wherein:
the working memory blocks each comprise a plurality of select lines and memory strings;
the memory strings each comprise a plurality of transistors;
drain lines and source lines of the plurality of transistors are alternately coupled to each other, and a select line is coupled to a gate line of a transistor at one end of the memory string; and
the peripheral circuit is configured to, in response to the operation instruction, input operation data to the plurality of select lines in the working memory block to obtain an operation result.

15. A method of operating a semiconductor device, comprising:
receiving an operation instruction, wherein the operation instruction comprises address information for determining a target memory region in a plurality of memory regions and a second number of working memory blocks in the target memory region, each memory region comprises a first number of memory blocks, and the second number is less than the first number; and
performing a corresponding operation on the working memory blocks in response to the operation instruction.

16. The method of claim 15, wherein:
the first number of memory blocks comprise a third number of failure memory blocks, and a sum of the second number and the third number is equal to the first number;
the receiving the operation instruction comprises:
receiving a first operation instruction and a second operation instruction, wherein address information in the first operation instruction and address information in the second operation instruction are for determining the same memory region in the plurality of memory regions and the second number of working memory blocks in the same memory region; and
the performing the corresponding operation on the working memory blocks in response to the operation instruction comprises:
performing a corresponding operation on the second number of working memory blocks in response to the first operation instruction and the second operation instruction.

17. The method of claim 15, wherein:
the first number of memory blocks comprise a third number of extra memory blocks, a sum of the second number and the third number is equal to the first number, and the address information comprises an address of the target memory region and addresses of the third number of extra memory blocks; and
the method further comprises:
outputting a first enable signal according to the address of the target memory region;
outputting a second enable signal according to the addresses of the third number of extra memory blocks and the first enable signal;
receiving a third enable signal, and outputting a fourth enable signal according to the second enable signal and the third enable signal, wherein the fourth enable signal is an XOR result of the second enable signal and the third enable signal; and
outputting a fifth enable signal to the second number of working memory blocks according to the fourth enable signal, wherein the fifth enable signal is for strobing the second number of working memory blocks.

18. The method of claim 15, wherein:
the operation instruction further comprises a sixth enable signal, and the sixth enable signal is for indicating that the target memory region is configured to perform a data storage operation; and
the method further comprises:
writing stored data to the target memory region in response to the operation instruction;
reading stored data from the target memory region in response to the operation instruction; or
erasing stored data in the target memory region in response to the operation instruction.

19. The method of claim 15, wherein:
the operation instruction further comprises a seventh enable signal, and the seventh enable signal is for indicating that the target memory region is configured to perform a computing-in-memory operation; and
in response to the operation instruction, the performing the corresponding operation on the working memory blocks comprises:
inputting operation data to the second number of working memory blocks to obtain an operation result in response to the operation instruction, the operation result being an operation result of the operation data and data stored in the working memory blocks.

20. A system, comprising:
a controller; and
a semiconductor device coupled to the controller, wherein the semiconductor device comprises:
a peripheral circuit; and
a memory cell array;
wherein the peripheral circuit is coupled to the memory cell array, and the memory cell array comprises a plurality of memory regions, wherein each memory region comprises a first number of memory blocks; and
wherein the peripheral circuit is configured to:
receive an operation instruction, wherein the operation instruction comprises address information for determining a target memory region in the plurality of memory regions and a second number of working memory blocks in the target memory region, and the second number is less than the first number; and
perform a corresponding operation on the working memory blocks in response to the operation instruction; or
a controller; and
a semiconductor device coupled to the controller, wherein the semiconductor device comprises:
a peripheral circuit; and
a memory cell array coupled to the peripheral circuit, wherein the memory cell array comprises a plurality of first-level memory elements each comprising a plurality of memory blocks, the plurality of memory blocks are configured in a plurality of second-level memory elements each comprising a first number of memory blocks, a second number of memory blocks in the first number of memory blocks act as working memory blocks, and the second number is less than the first number.
